(19) United States
(12) Patent Application Publication
(10) Pub. No.: US 2016/0207825 A1
(43) Pub. Date: Jul. 21, 2016

(54) LAMINATES WITH A POLYMERIC SCRATCH RESISTANT LAYER

(71) Applicant: CORNING INCORPORATED, Corning, NY (US)

(72) Inventors: Matthew Lee Black, Naples, NY (US); Charles Andrew Paulson, Painted Post, NY (US); Chandan Kumar Saha, Franklin, MI (US)

(21) Appl. No.: 14/915,400

(22) PCT Filed: Aug. 27, 2014
(86) PCT No.: PCT/US14/52821

§ 371 Date: Feb. 29, 2016

Related U.S. Application Data
(60) Provisional application No. 61/871,595, filed on Aug. 29, 2013.

(51) Int. Cl. C03C 17/00; C03C 21/00

(52) U.S. Cl. CPC C03C 17/009; C03C 21/002; C03C 2217/445; C03C 2217/475; C03C 2217/78

(57) ABSTRACT

One or more aspects of the disclosure pertain to a laminates including a substrate, such as a glass substrate, which may be strengthened, or a sapphire substrate, and a polymeric scratch resistant layer disposed on the substrate. In one or more embodiments, where a glass substrate is utilized, the average flexural strength of the glass substrate is maintained when combined with the polymeric scratch resistant layer. The polymeric scratch resistant layer may include a polymeric diamond-like carbon. In one or more embodiments, the polymeric scratch resistant layer forms a shearable interface with the glass substrate or comprises a plurality of sub-layers and a plurality of shearable interfaces between such plurality of sub-layers. Methods for forming such laminates are also disclosed.

### CROSS-REFERENCE TO RELATED APPLICATIONS

This application claims the benefit of priority under 35 U.S.C. §119 of U.S. Provisional Application Ser. No. 61/871,595, filed on Aug. 29, 2013, the content of which is relied upon and incorporated herein by reference in its entirety.

### BACKGROUND

The disclosure relates to laminates including inorganic substrates and a polymeric scratch resistant layer, and more particularly to laminates that can include a chemically strengthened glass substrate or crystalline substrate and a polymeric scratch resistant layer disposed thereon, and which exhibit retained strength.

A wide variety of applications incorporating amorphous substrates (e.g., glass) and crystalline substrates (e.g., glass ceramic or sapphire) need greater scratch resistance than what may be offered by bare substrates (i.e., substrates without any layers disposed thereon). Such applications include cover and display substrates in handheld or mobile devices, laptops, televisions etc.

Coatings having a combination of high hardness and low coefficient of friction (CoF) are known to help increase its scratch resistance especially under blunt or sharp contact sliding. Evidence suggests that the damage caused by blunt or sharp contact that occurs in a single event is a primary source of visible scratches in cover and display substrates used in mobile devices. Once a significant scratch appears on a cover or display substrate of a user input/display, the appearance of the product is degraded since the scratch causes an increase in light scattering, which may cause significant reduction in brightness, clarity and contrast of images on the display. Significant scratches can also affect the accuracy and reliability of touch sensitive displays. These scratches, and even less significant scratches, are unsightly and can affect product performance.

Single event scratch damage can be contrasted with abrasion damage. Laminates used as cover substrates do not typically experience abrasion damage because abrasion damage is typically caused by reciprocating sliding contact from hard counter face objects (e.g., sand, gravel and sandpaper). Instead, laminates used in cover and display applications typically endure only reciprocating sliding contact from soft objects, such as fingers. In addition, abrasion damage can generate heat, which can degrade chemical bonds in the film materials and cause flaking and other types of damage to the glass-film laminate. In addition, since abrasion damage is often experienced over a longer term than the single events that cause scratches, the material experiencing abrasion damage can also oxidize, which further degrades the durability of the material and thus the laminate. The single events that cause scratches generally do not involve the same conditions as the events that cause abrasion damage and therefore, the solutions often utilized to prevent abrasion damage may not be applicable to prevent scratches in laminates described herein. Moreover, known scratch and abrasion damage solutions often compromise the optical properties, which is not acceptable in most cover and display applications.

Chemically strengthened glass substrates having high compressive stress (CS) have greater surface modulus (e.g., a surface modulus that is about 10% greater and greater hardness than non-strengthened glass substrates. Moreover, known crystalline substrates, such as sapphire substrates, also exhibit greater hardness than other substrates. However, despite these properties, strengthened glass substrates and crystalline substrates are as susceptible to scratching as are non-strengthened glass substrates and other substrates. One solution to prevent scratching of such substrates is to apply a low friction layer on the surface of the substrate.

Accordingly, there is a need for a material that exhibits a low static and dynamic CoF, when applied to various substrates, and inhibits the formation of scratches on such substrates. There is also a need for laminates that include a layer of such material that exhibits improved scratch resistance, even during high loading, for example, loading with a Berkovitch diamond indenter using a force of about 30-160 mN.

### SUMMARY

A first aspect of this disclosure pertains to a laminate including a substrate, which may be transparent, having opposing major surfaces and a polymeric scratch resistant layer disposed on a first major surface. The substrate exhibits an average flexural strength that is maintained when combined with the polymeric scratch resistant layer. In a specific embodiment, the laminate exhibits a second average flexural strength that is at least 90% of the average flexural strength of the substrate.

The substrate may include a chemically-strengthened glass substrate or a sapphire substrate. In embodiments that utilize a chemically-strengthened glass substrate, such a substrate may exhibit a surface compressive strength greater than 500 MPa, a central tension greater than 18 MPa, and/or a depth of compressive layer greater than about 15 μm.

In one or more embodiments, the polymeric scratch includes polymeric diamond-like carbon. The polymeric scratch resistant layer may include a greater number of hydrogen-carbon bonds than carbon-carbon bonds. In one variant, the polymeric scratch resistant layer includes a non-zero amount of hydrogen up to about 40 atomic %.

The polymeric scratch resistant layer may be in direct contact with the substrate and/or may be formed from a single layer or may include a plurality of sub-layers. Optionally, the laminate may include one or more additional layers disposed on the first major surface of the substrate.

In one variant, the polymeric scratch resistant layer may exhibit a load-sensitive coefficient of friction that decreases with increasing load applied to the polymeric scratch resistant layer. In another variant, the polymeric scratch resistant layer exhibits coefficient of friction in the range from about 0.05 to less than about 0.4. The polymeric scratch resistant layer may exhibit a non-zero hardness up to about 20 GPa and/or have a thickness in the range from about 2 nm to about 1 μm.

In one or more embodiments, the polymeric scratch resistant layer absorbs energy from a contact force applied thereto. In another embodiment, the polymeric scratch resistant layer exhibits viscoelastic behavior upon application of a force to the polymeric scratch resistant layer. In yet another embodiment, the polymeric scratch resistant layer and the substrate form a shearable interface. The polymeric scratch resistant layer may include a plurality of sub-layers and a plurality of shearable interfaces between the plurality of sub-layers. In one or more embodiments, the polymeric scratch resistant layer may be deformable and/or may include a plurality of polymeric chains forming a network such that deformation of the polymeric scratch resistant layer causes shearing between the polymeric chains.

In one or more embodiments, the laminate may be assembled or included in an electronic device. In one or more embodiment, the laminate may exhibit a transparency in the range from about 70% to about 90%, at a wavelength in the range from about 400 nm to about 850 nm.

A second aspect of this disclosure pertains to a method of forming a laminate. In one or more embodiment, the method includes providing a substrate having opposing major surfaces and providing scratch resistance to the substrate by forming a polymeric scratch resistant layer on a first major surface of the substrate, for example, via vacuum deposition. In one or more embodiments, the substrate may include a chemically strengthened glass substrate and providing scratch resistance to the substrate further prevents a reduction in the average flexural strength of the chemically strengthened glass substrate. In embodiments which utilize a glass substrate, the method may include chemically strengthening the glass substrate to provide a chemically strengthened glass substrate having an average flexural strength. The method may also include providing one or more additional layers on the substrate. In one variant, the polymeric scratch resistant layer is in direct contact with the first major surface of the substrate and the one or more additional layers are in direct contact with the polymeric scratch resistant layer.

Additional features and advantages will be set forth in the detailed description that follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is an illustration of a laminate comprising a substrate and a polymeric scratch resistant layer, according to one or more embodiments.

FIG. 2 illustrates the variations in diamond-like carbon (DLC) materials.

FIG. 3 is an illustration of a laminate comprising a substrate and a polymeric scratch resistant layer, according to one or more embodiments.

FIG. 4 is a plot showing the relationship between CS, CoF and load on the cracking behavior of a bare, chemically strengthened glass substrate against blunt sliding friction using steel and glass spheres.

FIG. 5 illustrates the Raman spectra of polymeric scratch resistant layers according to one or more embodiments.

FIG. 6 is a plot illustrating the relationship between the deposition time used to form a polymeric scratch resistant layer and the thickness of the polymeric scratch resistant layer, according to one or more embodiments.

FIG. 7 is a plot illustrating the relationship between the RF power used during deposition and the deposition rate of a polymeric scratch resistant layer, according to one or more embodiments.

FIG. 8 is a plot illustrating the relationship between the butane gas flow used to form a polymeric scratch resistant layer and the deposition rate of the polymeric scratch resistant layer, according to one or more embodiments.

FIG. 9A illustrates the nano-indentation test results of the bare substrate used in Example 2C.

FIG. 9B illustrates the nano-indentation test results of the laminate of Example 2C from run 3.

FIG. 10A illustrates the nano-indentation test results of the bare substrate used in Example 2D.

FIG. 10B illustrates the nano-indentation test results of the laminate of Example 2D from run 3.

FIG. 11A illustrates the nano-indentation test results of the bare substrate used in Example 2B.

FIG. 11B illustrates the nano-indentation test results of the laminate of Example 2B from run 3.

FIG. 12 illustrates an optical microscope image of a polymeric scratch resistant layer and glass substrate laminate;

FIG. 13 illustrates the nano-indentation test results of the laminate of Example 2C from run 1.

FIG. 14 illustrates a plot of critical delamination load for Examples 2B-2D, from runs 1-7.

### DETAILED DESCRIPTION

In the following detailed description, numerous specific details may be set forth in order to provide a thorough understanding of embodiments of the disclosure. However, it will be clear to one skilled in the art when embodiments of the disclosure may be practiced without some or all of these specific details. In other instances, well-known features or processes may not be described in detail so as not to unnecessarily obscure the disclosure. In addition, like or identical reference numerals may be used to identify common or similar elements.

Whenever a group is described herein as comprising at least one of a group of elements and combinations thereof, it is understood that the group may comprise, consist essentially of, or consist of any number of those elements recited, either individually or in combination with each other. Similarly, whenever a group is described as consisting of at least one of a group of elements or combinations thereof, it is understood that the group may consist of any number of those elements recited, either individually or in combination with each other. Unless otherwise specified, a range of values, when recited, includes both the upper and lower limits of the range as well as any sub-ranges therebetween. Unless otherwise specified, all compositions and relationships that include constituents of compositions described herein are expressed in mole percent (mol %).

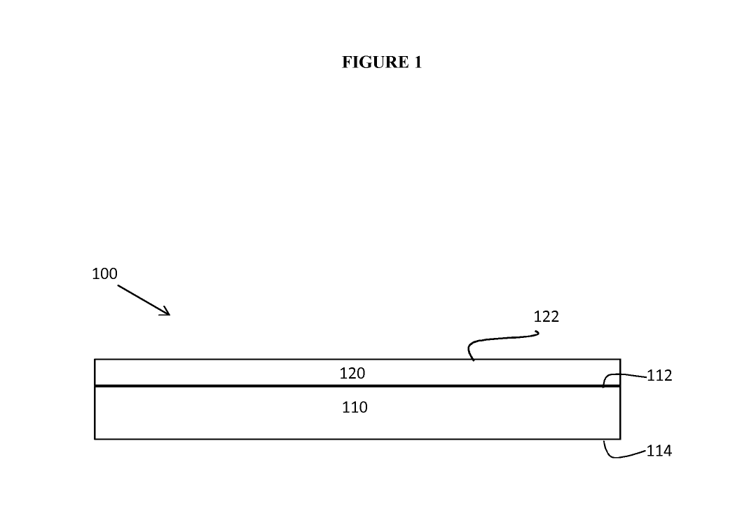

FIG. 1 illustrates one or more embodiments of the laminate 100. Laminate 100 can include a substrate 110 having a first major surface 112 and a second major surface 114. The laminate 100 also includes a polymeric scratch resistant layer 120 disposed on the first major surface 112. The polymeric scratch resistant layer 120 may be disposed on the second major surface 114, either or both of the minor surfaces (not shown) of the substrate 110, in addition to or instead of being disposed on the first major surface 112.

As used herein, the term “dispose” includes coating, depositing and/or forming a material onto a surface using any known method in the art. The disposed material may constitute a layer as defined herein. The phrase “disposed on” includes the instance of forming a material onto a surface such that the material is in direct contact with the surface and also includes the instance where the material is formed on a surface, where one or more intervening material(s) is between the disposed material and the surface. The intervening material(s) may constitute a layer, as defined herein.

The term “layer”, as applied to the polymeric scratch resistant layer 120 and/or other layers incorporated into the laminate 100, includes one or more sub-layers that are formed by any known method in the art, including discrete deposition or continuous deposition processes. Such sub-layers may be in direct contact with one another. The sub-layers may be formed from the same material or more than one different material. In one or more alternative embodiments, such sub-layers may have intervening sub-layers of different materials disposed therebetween. In one or more embodiments a layer may include one or more contiguous and uninterrupted sub-layers and/or one or more discontinuous and interrupted sub-layers (i.e., a sub-layer having different materials formed adjacent to one another).

As shown in FIG. 1, the substrate 110 may include an amorphous substrate, a crystalline substrate or a combination thereof. In one or more embodiments, the amorphous substrate may include glass, which may be strengthened or non-strengthened. Examples of suitable glass include soda lime glass, alkali aluminosilicate glass, alkali containing borosilicate glass and alkali aluminoborosilicate glass. In some variants, the glass may be free of lithia. In one or more alternative embodiments, the substrate 110 may include crystalline substrates such as glass ceramic substrates (which may be strengthened or non-strengthened) or may include a single crystal structure, such as sapphire. In one or more specific embodiments, the substrate 110 includes an amorphous base (e.g., glass) and a crystalline cladding (e.g., sapphire layer, a polycrystalline alumina layer and/or or a spinel (MgAl₂O₄) layer).

The substrates 110 disclosed herein may be substantially planar, although other embodiments may utilize a curved or otherwise shaped or sculpted substrate. The substrate 110 may be substantially clear, transparent and free from light scattering. The substrate may have a refractive index in the range from about 1.45 to about 1.55. In one or more embodiments, the substrate 110 may include a glass substrate or a glass ceramic substrate, which may be strengthened or characterized as strong, as will be described in greater detail herein. In such embodiments, the substrate 110 may be pristine and flaw-free before such strengthening. Where strengthened or strong substrates 110 are utilized, such substrates may be characterized as having a high average flexural strength (when compared to glass substrates that are not strengthened or strong) or high surface strain-to-failure (when compared to glass substrates that are not strengthened or strong) on one or more major opposing surfaces of such substrates.

Additionally or alternatively, the thickness of the substrate 110 may vary along one or more of its dimensions for aesthetic and/or functional reasons. For example, the edges of the substrate 110 may be thicker as compared to more central regions of the glass substrate 110. The length, width and thickness dimensions of the substrate 110 may also vary according to the laminate 100 application or use.

The substrate 110 according to one or more embodiments includes an average flexural strength that may be measured before and after the substrate 110 is combined with the polymeric scratch resistant layer 120. In embodiments described herein, the laminate 100 retains its average flexural strength after the combination of the substrate 110 with the polymeric scratch resistant layer 120, when compared to the average flexural strength of the substrate 110 before such combination. In one or more embodiments, the average flexural strength of the laminate 100 is substantially the same before and after the polymeric scratch resistant layer 120 is disposed on the substrate 110. In one or more specific embodiments, the substrate 110 retains at least 90%, at least 92%, at least 94%, at least 96%, at least 98%, at least 99% and all ranges and sub-ranges thereof, of its original average flexural strength (i.e., the average flexural strength before combination with the polymeric scratch resistant layer 120) after combination with the polymeric scratch resistant layer.

In specific embodiments the substrate may exhibit an average strain-to-failure that is 0.5% or greater, 0.6% or greater, 0.7% or greater, 0.8% or greater, 0.9% or greater, 1% or greater, 1.1% or greater, 1.2% or greater, 1.3% or greater, 1.4% or greater 1.5% or greater or even 2% or greater. In specific embodiments, the glass substrate has an average strain-to-failure of 1.2%, 1.4%, 1.6%, 1.8%, 2.2%, 2.4%, 2.6%, 2.8% or 3% or greater. In one or more embodiments, the substrate 110 retains its average strain-to-failure after combination with the polymeric scratch resistant layer 120. In other words, the average strain-to-failure of the substrate 110 is substantially the same before and after the polymeric scratch resistant layer 120 is disposed on the substrate 110.

Where the substrate 110 includes a glass substrate, such glass substrates may be provided using a variety of different processes. For instance, example glass substrate forming methods include float glass processes and down-draw processes such as fusion draw and slot draw.

In the float glass process, a glass substrate that may be characterized by smooth surfaces and uniform thickness is made by floating molten glass on a bed of molten metal, typically tin. In an example process, molten glass that is fed onto the surface of the molten tin bed forms a floating glass ribbon. As the glass ribbon flows along the tin bath, the temperature is gradually decreased until the glass ribbon solidifies into a solid glass substrate that can be lifted from the tin onto rollers. Once off the bath, the glass substrate can be cooled further and annealed to reduce internal stress.

Down-draw processes produce glass substrates having a uniform thickness that possess relatively pristine surfaces. Because the average flexural strength of the glass substrate is controlled by the amount and size of surface flaws, a pristine surface that has had minimal contact has a higher initial strength. When this high strength glass substrate is then further strengthened (e.g., chemically), the resultant strength can be higher than that of a glass substrate with a surface that has been lapped and polished. Down-drawn glass substrates may be drawn to a thickness of less than about 2 mm. In addition, down drawn glass substrates have a very flat, smooth surface that can be used in its final application without costly grinding and polishing.

The fusion draw process, for example, uses a drawing tank that has a channel for accepting molten glass raw material. The channel has weirs that are open at the top along the length of the channel on both sides of the channel. When the channel fills with molten material, the molten glass overflows the weirs. Due to gravity, the molten glass flows down the outside surfaces of the drawing tank as two flowing glass films. These outside surfaces of the drawing tank extend down and inwardly so that they join at an edge below the drawing tank. The two flowing glass films join at this edge to fuse and form a single flowing glass substrate. The fusion draw method offers the advantage that, because the two glass films flowing over the channel fuse together, neither of the outside surfaces of the resulting glass substrate comes in contact with any part of the apparatus. Thus, the surface properties of the fusion drawn glass substrate are not affected by such contact.

The slot draw process is distinct from the fusion draw method. In slow draw processes, the molten raw material glass is provided to a drawing tank. The bottom of the drawing tank has an open slot with a nozzle that extends the length of the slot. The molten glass flows through the slot/nozzle and is drawn downward as a continuous substrate and into an annealing region.

In some embodiments, the glass substrate used in the glass substrate 110 may be batched with 0-2 mol. % of at least one fining agent selected from a group that includes Na₂SO₄, NaCl, NaF, NaBr, K₂SO₄, KCl, KF, KBr, and SnO₂.

Once formed, glass substrates may be strengthened to form strengthened glass substrates. As used herein, the term “strengthened glass substrate” may refer to a glass substrate that has been chemically strengthened, for example through ion-exchange of larger ions for smaller ions in the surface of the glass substrate. However, other strengthening methods known in the art, such as thermal tempering, may be utilized to form strengthened glass substrates. As will be described, strengthened glass substrates may include a glass substrate having a surface compressive stress in its surface that aids in the strength preservation of the glass substrate. Strong glass substrates are also within the scope of this disclosure and include glass substrates that may not have undergone a specific strengthening process, and may not have a surface compressive stress, but are nevertheless strong. Such strong glass substrates articles may be defined as glass sheet articles (which are distinguished from a glass fiber articles) or glass substrates having an average strain-to-failure greater than about 0.5%, 0.7%, 1%, 1.5%, or even greater than 2%. Such strong glass substrates can be made, for example, by protecting the pristine glass surfaces after melting and forming the glass substrate. An example of such protection occurs in a fusion draw method, where the surfaces of the glass films do not come into contact with any part of the apparatus or other surface after forming. The glass substrates formed from a fusion draw method derive their strength from their pristine surface quality. A pristine surface quality can also be achieved through etching or polishing and subsequent protection of glass substrate surfaces, and other methods known in the art. In one or more embodiments, both strengthened glass substrates and the strong glass substrates may comprise glass sheet articles having an average strain to failure greater than about 0.5%, 0.7%, 1%, 1.5%, or even greater than 2%.

As mentioned above, the glass substrates described herein may be chemically strengthened by an ion exchange process to provide a strengthened glass substrate 110. The glass substrate may also be strengthened by other methods known in the art, such as thermal tempering. In the ion-exchange process, typically by immersion of the glass substrate into a molten salt bath for a predetermined period of time, ions at or near the surface(s) of the glass substrate are exchanged for larger metal ions from the salt bath. In one embodiment, the temperature of the molten salt bath is about 380-430° C. and the predetermined time period is about four to about eight hours. The incorporation of the larger ions into the glass substrate strengthens the glass substrate by creating a compressive stress in a near surface region or in regions at and adjacent to the surface(s) of the glass substrate. A corresponding tensile stress is induced within a central region or regions at a distance from the surface(s) of the glass substrate to balance the compressive stress. Glass substrates utilizing this strengthening process may be described more specifically as chemically-strengthened glass substrates 110 or ion-exchanged glass substrates 110. Glass substrates that are not strengthened may be referred to herein as non-strengthened glass substrates.

In one example, sodium ions in a strengthened glass substrate 110 are replaced by potassium ions from the molten bath, such as a potassium nitrate salt bath, though other alkali metal ions having larger atomic radii, such as rubidium or cesium, can replace smaller alkali metal ions in the glass. According to particular embodiments, smaller alkali metal ions in the glass can be replaced by Ag⁺ ions. Similarly, other alkali metal salts such as, but not limited to, sulfates, phosphates, halides, and the like may be used in the ion exchange process.

The replacement of smaller ions by larger ions at a temperature below that at which the glass network can relax produces a distribution of ions across the surface(s) of the strengthened glass substrate 110 that results in a stress profile. The larger volume of the incoming ion produces a compressive stress (CS) on the surface and tension (central tension, or CT) in the center of the strengthened glass substrate 110. The compressive stress is related to the central tension by the following relationship:

$$CS = CT ( \frac{t - 2 DOL}{DOL} )$$

where t is the total thickness of the strengthened glass substrate 110 and compressive depth of layer (DOL) is the depth of exchange. Depth of exchange may be described as the depth within the strengthened glass substrate 110 (i.e., the distance from a surface of the glass substrate to a central region of the glass substrate), at which ion exchange facilitated by the ion exchange process takes place.

In one embodiment, a strengthened glass substrate 110 can have a surface compressive stress of 300 MPa or greater, e.g., 400 MPa or greater, 450 MPa or greater, 500 MPa or greater, 550 MPa or greater, 600 MPa or greater, 650 MPa or greater, 700 MPa or greater, 750 MPa or greater or 800 MPa or greater. The strengthened glass substrate 110 may have a compressive depth of layer 15 μm or greater, 20 μm or greater (e.g., 25 μm, 30 μm, 35 μm, 40 μm, 45 μm, 50 μm or greater) and/or a central tension of 10 MPa or greater, 20 MPa or greater, 30 MPa or greater, 40 MPa or greater (e.g., 42 MPa, 45 MPa, or 50 MPa or greater) but less than 100 MPa (e.g., 95, 90, 85, 80, 75, 70, 65, 60, 55 MPa or less). In one or more specific embodiments, the strengthened glass substrate 110 has one or more of the following: a surface compressive stress greater than 500 MPa, a depth of compressive layer greater than 15 μm, and a central tension greater than 18 MPa.

Without being bound by theory, it is believed that strengthened glass substrates 110 with a surface compressive stress greater than 500 MPa and a compressive depth of layer greater than about 15 μm typically have greater strain-to-failure than non-strengthened glass substrates (or, in other words, glass substrates that have not been ion exchanged or otherwise strengthened). In some embodiments, the benefits of one or more embodiments described herein may not be as prominent with non-strengthened or weakly strengthened types of glass substrates that do not meet these levels of surface compressive stress or compressive depth of layer, because of the presence of handling or common glass surface damage events in many typical applications. However, as mentioned previously, in other specific applications where the glass substrate surfaces can be adequately protected from scratches or surface damage (for example by a protective coating or other layers), strong glass substrates with a relatively high strain-to-failure can also be created through forming and protection of a pristine glass surface quality, using methods such as the fusion forming method. In these alternate applications, the benefits of one or more embodiments described herein can be similarly realized.

Example ion-exchangeable glasses that may be used in the strengthened glass substrate 110 may include alkali aluminosilicate glass compositions or alkali aluminoborosilicate glass compositions, though other glass compositions are contemplated. As used herein, “ion exchangeable” means that a glass substrate is capable of exchanging cations located at or near the surface of the glass substrate with cations of the same valence that are either larger or smaller in size. One example glass composition comprises SiO₂, B₂O₃ and Na₂O, where (SiO₂+B₂O₃)≧66 mol. %, and Na₂O≧9 mol. %. In an embodiment, the glass substrate 110 includes a glass composition with at least 6 wt. % aluminum oxide. In a further embodiment, a glass substrate 110 includes a glass composition with one or more alkaline earth oxides, such that a content of alkaline earth oxides is at least 5 wt. %. Suitable glass compositions, in some embodiments, further comprise at least one of K₂O, MgO, and CaO. In a particular embodiment, the glass compositions used in the glass substrate 110 can comprise 61-75 mol. % SiO₂; 7-15 mol. % Al₂O₃; 0-12 mol. % B₂O₃; 9-21 mol. % Na₂O; 0-4 mol. % K₂O; 0-7 mol. % MgO; and 0-3 mol. % CaO.

A further example glass composition suitable for the glass substrate 110, which may optionally be strengthened or strong, comprises: 60-70 mol. % SiO₂; 6-14 mol. % Al₂O₃; 0-15 mol. % B₂O₃; 0-15 mol. % Li₂O; 0-20 mol. % Na₂O; 0-10 mol. % K₂O; 0-8 mol. % MgO; 0-10 mol. % CaO; 0-5 mol. % ZrO₂; 0-1 mol. % SnO₂; 0-1 mol. % CeO₂; less than 50 ppm As₂O₃; and less than 50 ppm Sb₂O₃; where 12 mol. %≦(Li₂O+Na₂O+K₂O)≦20 mol. % and 0 mol. %≦(MgO+CaO)≦10 mol. %.

A still further example glass composition suitable for the glass substrate 110, which may optionally be strengthened or strong, comprises: 63.5-66.5 mol. % SiO₂; 8-12 mol. % Al₂O₃; 0-3 mol. % B₂O₃; 0-5 mol. % Li₂O; 8-18 mol. % Na₂O; 0-5 mol. % K₂O; 1-7 mol. % MgO; 0-2.5 mol. % CaO; 0-3 mol. % ZrO₂; 0.05-0.25 mol. % SnO₂; 0.05-0.5 mol. % CeO₂; less than 50 ppm As₂O₃; and less than 50 ppm Sb₂O₃; where 14 mol. %≦(Li₂O+Na₂O+K₂O)≦18 mol. % and 2 mol. %≦(MgO+CaO)≦7 mol. %.

In a particular embodiment, an alkali aluminosilicate glass composition suitable for the glass substrate 110, which may optionally be strengthened or strong, comprises alumina, at least one alkali metal and, in some embodiments, greater than 50 mol. % SiO₂, in other embodiments at least 58 mol. % SiO₂, and in still other embodiments at least 60 mol. % SiO₂, wherein the ratio

$$\frac{{Al}_{2} {O}_{3} + {B}_{2} {O}_{3}}{\sum modifiers} > 1 ,$$

where in the ratio the components are expressed in mol. % and the modifiers are alkali metal oxides. This glass composition, in particular embodiments, comprises, consists essentially of, or consists of: 58-72 mol. % SiO₂; 9-17 mol. % Al₂O₃; 2-12 mol. % B₂O₃; 8-16 mol. % Na₂O; and 0-4 mol. % K₂O, wherein the ratio

$$\frac{{Al}_{2} {O}_{3} + {B}_{2} {O}_{3}}{\sum modifiers} > 1.$$

In still another embodiment, the glass substrate, which may optionally be strengthened or strong, may include an alkali aluminosilicate glass composition comprising: 64-68 mol. % SiO₂; 12-16 mol. % Na₂O; 8-12 mol. % Al₂O₃; 0-3 mol. % B₂O₃; 2-5 mol. % K₂O; 4-6 mol. % MgO; and 0-5 mol. % CaO, wherein: 66 mol. %≦SiO₂+B₂O₃+CaO≦69 mol. %; Na₂O+K₂O+B₂O₃+MgO+CaO+SrO>10 mol. %; 5 mol. %≦MgO+CaO+SrO≦8 mol. %; (Na₂O+B₂O₃)—Al₂O₃≦2 mol. %; 2 mol. %≦Na₂O—Al₂O₃≦6 mol. %; and 4 mol. %≦(Na₂O+K₂O)—Al₂O₃≦10 mol. %.

In an alternative embodiment, the glass substrate 110, which may optionally be strengthened or strong, may comprise an alkali aluminosilicate glass composition comprising, consisting essentially of, or consisting of: 2 mol % or more of Al₂O₃ and/or ZrO₂, or 4 mol % or more of Al₂O₃ and/or ZrO₂.

Where the substrate 110 includes a crystalline substrate, the substrate may include a single crystal, which may include Al₂O₃. Such single crystal substrates are referred to as sapphire. Other suitable materials for a crystalline substrate include polycrystalline alumina layer and/or or a spinel (MgAl₂O₄).

Optionally, the crystalline substrate 110 may include a glass ceramic substrate, which may be strengthened or non-strengthened. Examples of suitable glass ceramics may include Li₂O—Al₂O₃—SiO₂ system (i.e. LAS-System) glass ceramics, MgO—Al₂O₃—SiO₂ System (i.e. MAS-System) glass ceramics and/or glass ceramics that include a predominant crystal phase including β-quartz solid solution, β-spodumene ss, cordierite, and lithium disilicate. The glass ceramic substrates may be strengthened using the glass substrate strengthening processes disclosed herein. In one or more embodiments, MAS-System glass ceramic substrates may be strengthened in Li₂SO₄ molten salt, whereby 2Li⁺ for Mg²⁺ exchange can occur.

The substrate 110 according to one or more embodiments can have a thickness ranging from about 100 μm to 5 mm. Example substrate 110 thicknesses range from 100 μm to 500 μm, e.g., 100, 200, 300, 400 or 500 μm. Further example substrate 110 thicknesses range from 500 μm to 1000 μm, e.g., 500, 600, 700, 800, 900 or 1000 μm. The substrate 110 may have a thickness greater than 1 mm, e.g., about 2, 3, 4, or 5 mm. In one or more specific embodiments, the substrate 110 may have a thickness of 2 mm or less or less than 1 mm. The substrate 110 may be acid polished or otherwise treated to remove or reduce the effect of surface flaws.

Polymeric Scratch Resistant Layer

The polymeric scratch resistant layer may include polymeric DLC, as described herein, nitrogen phosphorous polymers that are amorphous (e.g., phosphozenes), boron nitride, and other similar materials.

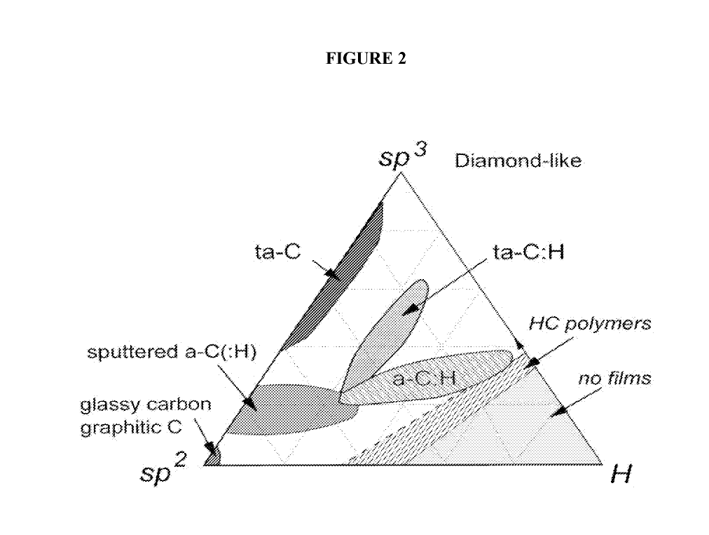

As used herein, the term DLC refers to carbon-containing materials with a wide variety of composition and structure. With specific regard to the term DLC, or diamond-like carbon, carbon atoms have the unique ability to form different types of covalent bonds with neighboring atoms. For example, the covalent bonds may be directed in three special dimensions. Carbon includes six electrons, with only four of such electrons participating in bonding. Of these four electrons, one 2s electron orbital and three 2p electron orbitals can hybridize in three different ways to form three different bonds (i.e., sp, sp², and sp³) and provide different allotropes. Accordingly, DLC can be varied to have different properties and can include soft polymeric graphitic films with low hardness, medium-hard hydrogenated amorphous carbon (a-C:H), and very hard tetrahedral a-C or a-C:H, and ultra-hard polycrystalline diamond. DLC materials can be tuned to have high hardness and can be combined with a variety of substrates (e.g., metals, plastics, and glass) to improve the wear and scratch resistance of the substrate materials. FIG. 2 presents a ternary phase diagram of carbon. As shown in FIG. 2, materials with exclusively or predominantly sp³ and sp² bonded carbon atoms are diamond-like and graphitic, respectively, with no or little hydrogen. Other carbon-containing materials with varying levels of hydrogen can also be produced.

DLC materials may be deposited using a variety of methods, as shown in Table 1. DLC layers deposited using a plasma-enhanced CVD process can include up to 60% hydrogen. Other deposition processes (e.g., sputtering or vacuum arc) may be utilized to form DLC layers with little to no hydrogen.

TABLE 1
Carbon materials.

| Carbon Material | Exemplary Preparation | |
|---|---|---|
| Type | Method | Hardness |
| Polymeric or | Evaporation plasma | Relatively soft |
| graphitic | polymerization | |
| a-C | Sputtering | Low hardness |
| a-C:H | Biased-plasma | High hardness |
| Tetrahedral a-C or | Ion beam deposition | High hardness |
| a-C:H | | |
| Polycrystalline | Thermal chemical vapor | Ultra high |
| diamond | deposition (CVD), flame | hardness |
| | CVD, microwave plasma | |

The concentration of sp, sp² or sp³ carbon bonding in DLC materials may also be tuned in various ways. For example, DLC materials that are rich in sp³ carbon bonds have been formed into a layer using ion-beam deposition. Such DLC materials may include some (i.e., non-zero) hydrogen content and exhibit high mass density with extremely high mechanical hardness, low CoF, high transparency, and chemically inertness. DLC materials that are rich in sp² carbon bonds have been used most commonly on soda lime glass substrates to provide scratch resistance to such glass substrates via the high hardness of the DLC materials. In such instances, layers of DLC can include highly tetrahedral amorphous carbon (e.g., at least 35% or even 80% sp³ carbon-carbon bonds) and/or high hardness (e.g., at least 10 GPa or even in the range from about 20 GPa to about 80 GPa). In some instances, the adhesion of such hard DLC layers to underlying substrates was provided by ion-milling to remove nano-cracks and/or reducing the sodium content of the substrate (e.g., in the case of glass substrates). Other DLC materials can include dopants such as boron or silicon. The foregoing types of DLC materials focus on increasing hardness to provide scratch resistance. Typical DLC materials used for scratch resistance are characterized by high or ultra-high hardness, low CoF (e.g., 0.05 or less), and high internal stresses. As will be described herein, the polymeric scratch resistant layer 120 is formed from a material that is relatively soft, when compared to known DLC materials, and provides scratch resistance while maintaining the strength in the underlying substrate.

In one or more embodiments, the polymeric scratch resistant layer 120 may exhibit a non-zero hardness up to about 20 GPa, or more specifically in the range from about 10 GPa to about 18 GPa or from about 12 GPa to about 16 GPa. In specific embodiments, the polymeric scratch resistant layer may exhibit a hardness of about 10 GPa, 10.5 GPa, 11 GPa, 11.5 GPa, 12 GPa, 12.5 GPa, 13 GPa, 13.5 GPa, 14 GPa, 14.5 GPa, 15 GPa, 15.5 GPa, 16 GPa, 16.5 GPa, 17 GPa, 18 GPa, 18.5 GPa, 19 GPa, 19.5 GPa, 20 GPa, and all ranges and sub-ranges therebetween. As used herein, hardness values can be measured using known diamond nano-indentation methods that are commonly used for determining the modulus and hardness of films. Exemplary diamond nano-indentation methods may utilize a Berkovich diamond indenter.

In one or more embodiments, the polymeric scratch resistant layer 120 includes a polymeric DLC with an amorphous network of carbon-hydrogen bonds and carbon-carbon bonds, which sometimes form polymeric chains within the network. In some instances, the carbon-carbon bonds are network bonds and are not terminating bonds. In one or more embodiments, the polymeric DLC does not include any dopants and only includes carbon and hydrogen atoms. The polymeric DLC utilized in one or more embodiments may include a greater number of carbon-hydrogen bonds than carbon-carbon bonds. Polymeric DLC may include a carbon content of at least about 60 atomic %, 61 atomic %, 62 atomic %, 63 atomic %, 64 atomic %, 65 atomic %, 66 atomic %, 67 atomic %, 68 atomic %, 69 atomic %, or even at least about 70 atomic %. Polymeric DLC may include a non-zero hydrogen content of about 40 atomic % or less, about 39 atomic % or less, about 38 atomic % or less, about 37 atomic % or less, about 36 atomic % or less, about 35 atomic % or less, about 34 atomic % or less, about 33 atomic % or less, about 32 atomic % or less, about 31 atomic % or less, or even about 30 atomic % or less. In one or more embodiments, polymeric DLC excludes polymeric graphitic carbon layers, non-hydrogenated amorphous carbon (a-C) layers or hydrogenated amorphous carbon layers (a-C:H), tetrahedral amorphous carbon layers (ta-C), and diamond layers. Polymeric DLC may also exclude polymers such as polyethylene, polyacetylene and the like.

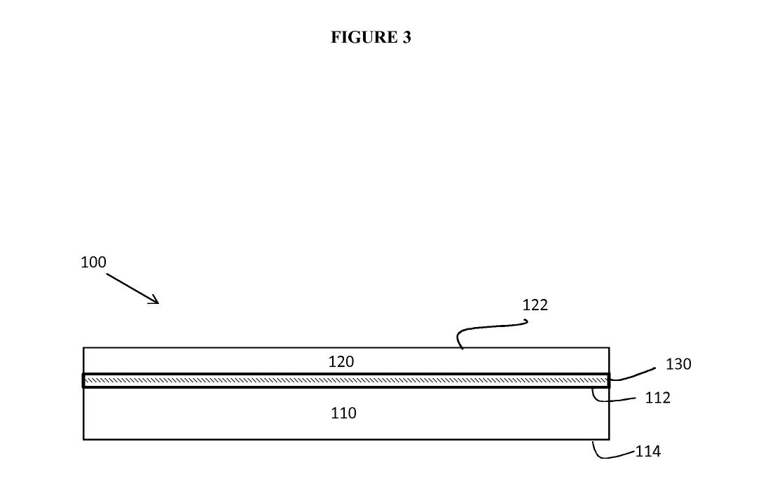

In one or more embodiments, the polymeric scratch resistant layer 120 may be in direct contact with the substrate 110. The laminate 100 may include one or more intervening layers between the polymeric scratch resistant layer 120 and the substrate 110. As shown in FIG. 3, the one or more intervening layers may include an adhesion promoting layer(s) 130. The adhesion promoting layer(s) 130 promote adhesion of the polymeric scratch resistant layer 120 to the substrate 110 by providing bond sites for the polymeric scratch resistant layer 120 to bond to the substrate 110. Such adhesion promoting layer(s) 130 may include a silicon-containing monolayer and/or nucleation layer(s) that can include silicon carbide, tantalum carbide, tungsten carbide or titanium carbide. In one or more embodiments, the silicon-containing monolayer may have a thickness (e.g., 1-10 angstroms) that does not impact the optical properties of the substrate 110 or the laminate 100. Without being bound by theory, carbon is believed to bond to free oxygen on a surface, such as the surface of the substrates 110 described herein, and will form carbon dioxide. Accordingly, bonding carbon to a substrate 110, which can include oxygen on its surface, can be difficult or it may be difficult to achieve the require adhesion for use of the laminate for its intended purpose(s). Further, as carbon readily forms covalent bonds and covalent networks, it is believed that a thin adhesion promoting layer 130 including silicon, can form bonds between the substrate (e.g., the SiO₂ in the substrate) and the carbon of the polymeric scratch resistant layer 120. Where the adhesion promoting layer 130 includes carbides such as TaC, WC, TiC and the like, such materials can also form bonds with the substrate, or specifically with the oxygen present on the substrate surface, and form carbides that bond to the carbon of the polymeric scratch resistant layer. The adhesion promoting layer(s) of one or more embodiments may have a non-zero thickness of less than about 50 nm, less than about 40 nm, less than about 30 nm, less than about 20 nm, less than about 10 nm, less than about 9 nm, less than about 8 nm, less than about 7 nm, less than about 6 nm, less than about 5 nm, less than about 4 nm, less than about 3 nm, less than about 2 nm, less than about 1 nm, less than about 0.9 nm, less than about 0.8 nm, less than about 0.7 nm, less than about 0.6 nm, less than about 0.5 nm, less than about 0.4 nm, less than about 0.3 nm, less than about 0.2 nm, less than about 0.1 nm and all ranges and sub-ranges therebetween. In some embodiments, the thickness of the adhesion promoting layer(s) may be controlled in view of the modulus of such layers. Without being bound by theory, high modulus materials used as adhesion promoting layer(s) may reduce the strength of the laminates and/or substrates. Accordingly, the thickness of adhesion promoting layer(s) utilizing high modulus materials may be limited. The polymeric scratch resistant layer 120 may provide the laminate 100 with an inert surface 122. In one or more embodiments, the chemical inertness of the inert surface 122 is due to, at least in part, to the hydrophobicity of the polymeric scratch resistant layer 120. In such embodiments, the polymeric scratch resistant layer 120 does not swell when exposed to water or moisture. In one or more embodiments, the polymeric scratch resistant layer 120 may exhibit a water contact angle of greater than about 70°.

The polymeric scratch resistant layer 120 exhibits scratch resistance and strength retention properties (i.e., leading to the strength retention of the laminate 100) via different mechanisms, including the ability to absorb energy from applied forces, interlayer sliding and/or viscoelastic behavior. In one or more embodiments, the polymeric scratch resistant layer 120 exhibits energy absorption properties when a sharp or blunt contact force is applied to the polymeric scratch resistant layer. In one variant, the energy from such sharp or blunt contact forces is absorbed by the polymeric chains in the polymeric scratch resistant layer 120. This energy absorption leads to fewer scratches or shallower scratches, which are both less visible and less likely to degrade the optical properties of the laminate 100.

In one or more embodiments, the polymeric scratch resistant layer 120 exhibits scratch resistance and strength retention properties (i.e., leading to the strength retention of the laminate 100) due, at least partially, to interlayer sliding between 1) the sub-layers of the polymeric scratch resistant layer 120; 2) the polymeric scratch resistant layer 120 and the substrate 110; and/or 3) between the polymeric chains of the polymeric scratch resistant layer 120. This characteristic of the polymeric scratch resistant layer 120 may be contrasted with other types of DLC layers in which sp^{a} types of bonds are predominant and which do not exhibit interlayer sliding, as described herein.

In one or more embodiments, the polymeric scratch resistant layer 120 exhibits viscoelastic behavior upon application of a force to the polymeric scratch resistant layer. As used herein, the term viscoelastic behavior includes both viscous and elastic characteristics when a material undergoes deformation. In one or more embodiments, viscoelastic behavior includes the ability of a material to exhibit viscous flow upon application of a force. In one or more embodiments, application of a force to the polymeric scratch resistant layer 120 causes local shearing at the site of the applied force and the layer at least partially recovers or, sometimes, completely recovers and returns to its original state after such shearing. In or more embodiments, materials that exhibit viscoelastic behavior, such as the polymeric scratch resistant layer 120, may be described as resistant to cracks because of its ability for recovery from shearing. The polymeric scratch resistant layer 120 may exhibit viscoelastic behavior despite its high volume density of carbon bonds, which typically impart toughness and hardness.

In one or more embodiments, the polymeric scratch resistant layer 120 forms a shearable interface with the substrate 110. In a particular embodiment, the sub-layers of the polymeric scratch resistant layer 120 form a plurality of shearable interfaces therebetween. As used herein, shearable interface includes the interface at which one or both layers at such interface undergo shearing deformation that is caused by the application of a shear strain to a layer. In another embodiment, the polymeric scratch resistant layer 120 includes a plurality of polymeric chains forming a network and is deformable such that the deformation of the polymeric scratch resistant layer causes shearing between the polymeric chains.

In known laminates which do not include a polymeric scratch resistant layer 120 but include a glass laminate, when sharp contact loading is applied to such known laminates, micro-ductile deformation (which is permanent deformation via plastic deformation and/or densification) typically occurs. Such deformation can be a primary mode of failure that precedes cracking of the underlying glass substrate. Both failure modes (i.e., micro-ductile deformation and cracking) are thought to be independent of CoF. In contrast, the energy absorption that occurs in laminates 100 including a polymeric scratch resistant layer 120 allows energy dissipation during sharp contact loading and thus increases the scratch threshold of such layers. The increased scratch threshold may prevent or minimize microductile deformation. In one or more embodiments, the thickness of the polymeric scratch resistant layer 120 may be tuned to provide more opportunities for interlayer sliding (e.g., thicker layers may allow for a greater number of sub-layers and thus, more or greater opportunities for interlayer sliding between such sub-layers) and thus provide a higher scratch threshold or greater scratch resistance. As used herein, the term “scratch” includes single event scratches, multiple event scratches (e.g., abrasion damage), deep scratches, shallow and/or light scattering scratches. In one or more embodiments, the polymeric scratch resistant layer 120 includes multiple (i.e., more than 2) sub-layers to form a thicker layer. In such embodiments, the number of sub-layers to increase the thickness of the polymeric scratch resistant layer 120 is limited by the need to maintain the optical properties of the polymeric scratch resistant layer. In one or more embodiments, the number of sub-layers of the polymeric scratch resistant layer 120 may also be limited by the strength retention effect of the polymeric scratch resistant layer in the laminate.

In one or more embodiments, the polymeric scratch resistant layer 120 has a thickness in the range from about 10 nm to about 3 μm in the range from about 100 nm to about 2 μm, or more specifically, in the range from about 250 nm to about 1 μm. In one or more embodiments, the polymeric scratch resistant layer 120 has a thickness of about 200 nm, 225 nm, 250 nm, 300 nm, 325 nm, 350 nm, 375 nm, 400 nm, 425 nm, 450 nm, 475 nm, 500 nm, 525 nm, 550 nm, 575 nm, 600 nm, 625 nm, 650 nm, 675 nm, 700 nm, 725 nm, 750 nm, 775 nm, 800 nm, 825 nm, 850 nm, 875 nm, 900 nm, 925 nm, 950 nm, 975 nm, 1 μm, 1.1 μm, 1.2 μm, 1.3 μm, 1.4 μm, 1.5 μm, 1.6 μm, 1.7 μm, 1.8 μm, 1.9 μm, 2 μm, 2.1 μm, 2.2 μm, 2.3 μm, 2.4 μm, 2.5 μm, 2.6 μm, 2.7 μm, 2.8 μm, 2.9 μm, 3.0 μm and all ranges and sub-ranges therebetween.

As mentioned above, scratch damage in substrates may include and range from micro-ductile deformation of the substrate and cracking. Micro-ductile deformation is related to the hardness of a material, and can occur at a relatively low load. As the hardness of a material decreases, the load required to cause micro-ductile deformation also decreases. Conversely, as the hardness of a material increases, the load required to cause micro-ductile deformation also increases. Where the material is a glass substrate or a material disposed on a glass substrate (e.g., the polymeric scratch resistant layer 120), as the load applied is further increased glass cracking can result. The polymeric scratch resistant layer 120 exhibits resistance to micro-ductile deformation despite its relatively low hardness (when compared to known hard materials, such as hard DLC).

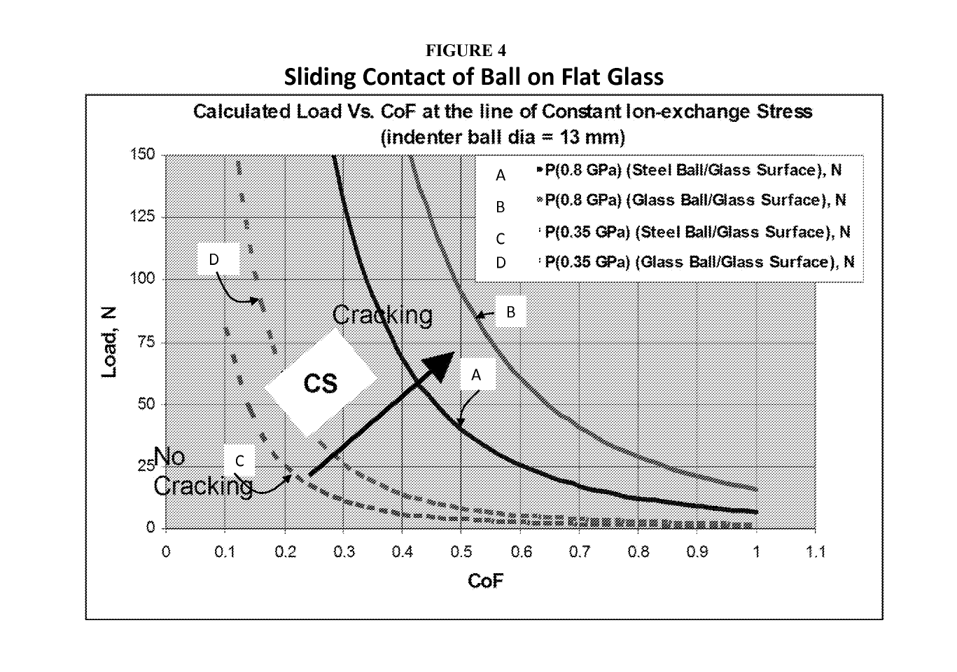

Further, the polymeric scratch resistant layer 120 exhibits the requisite CoF that can increase the load tolerance of the substrate 110 and thus the laminate 100. Such an increase in load tolerance can impart scratch resistance and crack resistance. Without being bound by theory, it is believed that the polymeric scratch resistant layer 120 does not crack as readily as other more brittle materials and, instead stretches or elongates when a load is applied. This resistance to cracking can prevent cracks from forming in the polymeric scratch resistant layer 120 and thus prevents cracks from propagating into the underlying substrate 110. Preventing crack formation and/or crack propagation preserves the strength of the laminate 100. FIG. 4 illustrates a model showing the interdependence of CS and CoF of a glass substrate, and load (P) applied thereto on the cracking behavior of the glass substrate against blunt sliding friction for steel and glass spheres. The glass substrate used in the model is bare and does not include a polymeric scratch resistant layer.

The inverse and nonlinear relation of P and CoF has been presented for two CS levels in the underlying glass substrate and varying indenter material couples to illustrate the theoretical boundaries of cracking vs. no-cracking zones. For each line indicating samples A-D, the left of the line indicates a no-cracking zone and the right of the line indicates a cracking zone, with cracking referring to the formation of a crack or the enlargement of an existing crack in the glass substrate as a result of the force applied to the glass substrate. As shown in FIG. 4, as CoF is decreased, the load required to cause cracking in the glass substrate increases. Moreover, as CS in the glass substrate increases, the boundary between the CoF at which the glass substrate exhibits cracking and at which the glass substrate does not exhibit cracking shifts to the right indicating tolerance of higher CoF at a given load or to a higher load for a given CoF. The converse is true for lower CS levels in the glass substrate. FIG. 4 also illustrates the effect of indenter material. When lower the modulus indenter material is utilized (e.g., E_{glass}<Eₛₜₑₑₗ, where E refers to Young's modulus), the glass substrate cracking threshold is increased. Since load may be independently controlled, scratch resistance (which is often characterized by cracking threshold) may be enhanced by either increasing the CS or by lowering CoF. The CoF of bare glass substrates (e.g., without a polymeric scratch resistant layer 120 disposed thereon) is relatively high (e.g., >0.7, when measured by applying metal to the glass substrate) and as a result its load tolerance is fairly low. Without being bound by theory, although CS may play a positive role, the CoF may play a much larger role in scratch resistance.

Moreover, although the effect of CS is beneficial to scratch resistance, the sliding contact from single event scratch damage introduces high tensile stress at the trailing edge of the contact between the indenter and a substrate or laminate 100. The loads often applied to glass substrates exceed the critical load required for cracking and as a result the CS alone may not provide sufficient barrier to scratch resistance or crack resistance. Accordingly, a reduction in CoF (i.e., by the incorporation of the polymeric scratch resistant layer 120 in the laminate 100) provides a useful mechanism to increase scratch resistance and crack resistance. The inclusion of a polymeric scratch resistant layer 120 provides such a reduction of CoF regardless of the CS of the underlying substrate.

In one or more embodiments, the polymeric scratch resistant layer 120 exhibits a CoF that is less than the CoF of the glass substrate 110. Unless otherwise specified, the term CoF as used herein, refers to the CoF measured by a sliding friction test where one body is in motion using a chrome-plated steel sphere having a diameter of 13 mm, using a normal load in the range from about 10N to about 50N to form a scratch having a length of 5 mm in the material being tested (e.g., polymeric scratch resistant layer 120 or substrate 110). The sphere is placed on the surface of the material, a constant load is applied and the sphere is displaced along the surface of the material. The glass substrate 110 may exhibit a CoF in the range from about 0.4 to about 0.9. The polymeric scratch resistant layer 120 may exhibit a CoF of less than 0.4. In one or more particular embodiments, the polymeric scratch resistant layer 120 may exhibit a CoF in the range from about 0.01 to less than about 0.4. In one or more specific embodiments, the polymeric scratch resistant layer 120 may exhibit a CoF in the range from about 0.05 to less than about 0.4 or in the range from about 0.05 to about 0.1. In particular embodiments, the CoF of the polymeric scratch resistant layer 120 may be about 0.01, 0.02, 0.03, 0.04, 0.05, 0.06, 0.07, 0.08, 0.09, 0.10, 0.11, 0.12, 0.13, 0.14, 0.15, 0.16, 0.17, 0.18, 0.19, 0.20, 0.21, 0.22, 0.23, 0.24, 0.25, 0.26, 0.27, 0.28, 0.29, 0.30, 0.31, 0.32, 0.33, 0.34, 0.35, 0.36, 0.37, 0.38, 0.39, 0.395, 0.399, 0.40, 0.42, 0.44, 0.46, 0.48, 0.50, 0.55, 0.60, 0.65, 0.70, 0.75, 0.80, 0.85, and all ranges and sub-ranges therebetween.

In one or more embodiments, the polymeric scratch resistant layer 120 exhibits such CoF values at high loads without being subjected to heat treatment and after being subjected to heat treatment. In such embodiments, heat treatment included subjecting the polymeric scratch resistant layer 120, after it is formed on a glass substrate 110 to temperatures up to and above about 300° C. for extended periods of time (e.g., from about 1 hour to about 50 hours).

Without being bound by theory, low CoF at substantially high load and upon high temperature exposure suggests that the polymeric scratch resistant layer 120 is able to withstand heavy and rugged use and provide enhanced protection to the glass substrate 110 from relatively high load and frictive abuse over wide range of temperature cycles. Moreover, the polymeric scratch resistant layer 120 exhibits this behavior and these properties even during sharp contact loading (in addition to blunt contact loading), where there is sufficient contact area between the indenter face and the polymeric scratch resistant layer, and/or when thicker (i.e., when the thickness of the polymeric scratch resistant layer 120 is appreciable compared to the indenter face area). Moreover, where the substrate includes a chemically strengthened glass substrate exhibiting a CS, at higher temperatures the stress in the glass substrate may relax and the CS may be degraded or lower. Such degradation in CS can often decrease the strength of the glass substrate. In such instances, the inclusion of a polymeric scratch resistant layer 120 may mitigate the decrease in strength of the glass substrate because the CoF of the laminate is lower or controlled regardless of any change in CS. The CoF can thus be used to prevent the formation of cracks in the polymeric scratch resistant layer and thus prevent propagation of cracks into the underlying substrate.

The polymeric scratch resistant layer 120 may also exhibit a load-sensitive CoF. In one or more embodiments, the CoF of the polymeric scratch resistant layer 120 decreases as an increasing load is applied to the polymeric scratch resistant layer. Without being bound by theory, the ability of the polymeric scratch resistant layer 120 to demonstrate low CoF at increasing load is believed to be due, at least partially, to interlayer sliding, as described herein.

The polymeric scratch resistant layer 120 may be formed via vacuum deposition processes, such as plasma-enhanced chemical vapor deposition. In one or more embodiments, the polymeric scratch resistant layer 120 is substantially free of surface damage typically caused by ions impinging the surface of other coatings that are formed via ion beam deposition methods.

In one or more embodiments, the laminate 100 may be transparent, as defined herein. As used herein, the term “transparent” may include an average light transmission of at least 70%. In one or more embodiment, the laminate 100 exhibits an average light transmission over the visible spectrum (e.g., 380 nm-780 nm) of at least 75%, at least 80%, at least 85%, at least 90%, of the value obtained using air as the reference medium. The term “light transmission” refers to the amount of light that is transmitted through a medium. The measure of light transmission is the ratio between the light incident on the medium and the amount of light exiting the medium (that is not reflected or absorbed by the medium). In other words, light transmission is the fraction of incident light that is both not reflected and not absorbed by a medium. The term “average light transmission” refers to spectral average of the light transmission multiplied by the luminous efficiency function, as described by CIE standard observer. In one or more embodiments, the laminate does not exhibit any absorption bands within this wavelength range and/or exhibits a maximum reflectivity of 30% absorbing or reflecting.

In accordance with a second aspect of this disclosure, an article may include the laminates 100 described herein. In one or more embodiments, such articles include consumer electronics such as mobile phones, tables, laptops, televisions, displays. In one or more specific embodiments, the laminate 100 may be incorporated into an electronic device housing. For example, the electronic device may form a laminate 100 as part of a front cover placed and secured to provide a front surface of the device and may form part of a display. The laminate may form a back cover placed and secured to provide a back surface of an electronic device. The laminate 100 may also be used in architectural structures (e.g., countertops or walls), appliances (e.g., cooktops, refrigerator and dishwasher doors, etc.), information displays (e.g., whiteboards), and automotive components (e.g., dashboard panels, windshields, window components, etc.).

A third aspect of this disclosure pertains to a method of forming a laminate. In one or more embodiments, the method includes providing a substrate 110 having an average flexural strength and preventing a decrease in the average flexural strength by forming a polymeric scratch resistant layer 120 on a first major surface of the chemically strengthened glass substrate. The substrate 110 may include a glass substrate and the method may include chemically strengthening the glass substrate. The polymeric scratch resistant layer 120 may be formed via vacuum deposition method, for example, plasma-enhanced chemical vapor deposition. In one option, the method includes placing the substrate 110 in a vacuum chamber and forming the polymeric scratch resistant layer 120 by introducing a butane gas (as a precursor to the polymeric scratch resistant layer) into the vacuum chamber containing the substrate. In another option, the method includes bonding the polymeric scratch resistant layer 120 to the substrate 110 by introducing a silane gas into the vacuum chamber prior to introducing the butane gas into the vacuum chamber or by simultaneously introducing a silane gas into the vacuum chamber when introducing the butane gas into the vacuum chamber. In one variant, the butane gas and/or silane gas are continuously flowed into the vacuum chamber until the desired thickness of the polymeric scratch resistant layer 120 is formed on the substrate. In another variant, the butane gas and/or silane gas are intermittently introduced either together or sequentially into the vacuum chamber to form one or more sub-layers of the polymeric scratch resistant layer 120. The adhesion of the sub-layers may be controlled by varying the sequence (i.e., simultaneously or sequentially) in which the butane and/or silane are introduced, the flow rates of the butane and/or silane and/or other deposition conditions.

The method may optionally include providing one or more additional layers on the substrate 110. For example, such additional layers may include an anti-reflective layer including materials such as SiO₂, Nb₂O₅, TiO₂ and the like. Such additional layer(s) may be formed in a vacuum chamber by flowing one or more precursor gases into the vacuum chamber (e.g., butane, argon, silane etc.). The additional layer(s) may be formed in the same or different vacuum chamber as the polymeric scratch resistant layer. In one or more embodiments, the additional layer(s) may be disposed on the polymeric scratch resistant layer 120 such that the polymeric scratch resistant layer is disposed between the substrate and the additional layer(s). In one or more alternative embodiments, the additional layer(s) may be disposed between the substrate 110 and the polymeric scratch resistant layer 120. In another embodiment, the additional layer may be disposed on the opposite surface of the substrate 110 from the polymeric scratch resistant layer 120. In such embodiments the additional layer may include indium-tin-oxide (ITO) or other transparent conductive oxides (e.g., aluminum and gallium doped zinc oxides and fluorine doped tin oxide), hard films of various kinds (e.g., diamond-like carbon, Al₂O₃, AlON, TiN, TiC), IR or UV reflecting layers, conducting or semiconducting layers, electronics layers, thin-film-transistor layers, or anti-reflection (“AR”) films (e.g., SiO₂ and TiO₂ layered structures).

### EXAMPLES

Various embodiments will be further clarified by the following examples. It will be apparent to those skilled in the art that various modifications and variations can be made without departing from the spirit or scope of the invention.

### Example 1

Examples A, B and C were prepared to evaluate the retained strength of the laminates according to one or more of the disclosed embodiments. Five samples of Example A, five samples of Example B and 5 samples of Example C were prepared by providing glass substrates having a thickness of about 0.7 mm, a length of about 50 mm, and a width of about 50 mm. The glass substrates included an aluminosilicate glass composition including 61-75 mol. % SiO₂; 7-15 mol. % Al₂O₃; 0-12 mol. % B₂O₃; 9-21 mol. % Na₂O; 0-4 mol. % K₂O; 0-7 mol. % MgO; and 0-3 mol. % CaO. The glass substrates were chemically strengthened to exhibit a CS of 790 MPa and a DOL of about 41 microns via an ion-exchange process in which the glass substrates were immersed in a molten potassium nitrate (KNO₃) bath that was heated to a temperature in the range from about 350° C. to 450° C. for a duration of 3-8 hours.

A polymeric scratch resistant layer was formed on one major surface of each of the glass substrate for Examples B and C using a plasma-enhanced chemical vapor deposition process. The glass substrates of Example A were not combined with a polymeric scratch resistant layer and were, instead, left bare. The glass substrates of Examples B and C were placed into a parallel plate reactor having a 24 inch diameter circular platen (for holding the glass substrates). A bias of about 650 V between an electrode and the platen was utilized to generate the plasma. RF power of about 750 W at 13.56 MHz was supplied to the reactor. Argon, used as a working gas, was flowed at a rate of about 5 sccm and butane, used as a source gas for the deposition of the polymeric scratch resistant layer, was flowed at a rate of 30 sccm into the reactor, which was held at a pressure of about 30 mTorr. The thickness of the polymeric scratch resistant layers on the samples of Examples B and C were 60 nm and 500 nm as shown in Table 1, respectively.

The average flexural strength of each of the samples was evaluated using ring-on-ring testing. Examples B and C were tested with the side with the polymeric scratch resistant layer in tension. For Example A, one side of the glass substrate was similarly in tension. The ring-on-ring testing parameters included a contact radius of 1.6 mm, a cross-head speed of 1.2 mm/minute, a load ring diameter of 0.5 inches, and a support ring diameter of 1 inch. Before testing, an adhesive film was placed on the compression side of the glass substrate (without the polymeric scratch resistant layer disposed thereon) and a fluoropolymer was applied on the tension side of the glass substrate (in the case of Example A) and the tension side or side on which the polymeric scratch resistant layer was disposed (in the case of Examples B and C) to contain any broken glass shards.

TABLE 1

| | | | | Polymeric | |
|---|---|---|---|---|---|
| | | | | Scratch | |
| | | | | Resistant | |
| | Substrate | Substrate | Substrate | Layer | |
| | Thickness | Length | Width | Thickness | Peak Load |
| Examples | Mm | mm | Mm | nm | kgf |
| 1A | 0.699 | 50.030 | 49.990 | 0 | 274.595 |
| (Comprative) | | | | | |
| 2A | 0.699 | 50.010 | 50.120 | 0 | 299.727 |
| (Comprative) | | | | | |
| 3A | 0.696 | 50.030 | 50.060 | 0 | 272.611 |
| (Comprative) | | | | | |
| 4A | 0.698 | 50.023 | 50.057 | 0 | 261.174 |
| (Comprative) | | | | | |
| 5A | 0.697 | 50.023 | 50.057 | 0 | 257.711 |
| (Comprative) | | | | | |
| Average Flexural Strength (ROR) | | | | | 273.163 |
| 1B | 0.697 | 50.023 | 50.057 | 60 | 359.489 |
| 2B | 0.695 | 50.023 | 50.057 | 60 | 244.059 |
| 3B | 0.712 | 50.023 | 50.057 | 60 | 219.704 |
| 4B | 0.697 | 50.023 | 50.057 | 60 | 395.078 |
| 5B | 0.696 | 50.023 | 50.057 | 60 | 297.284 |
| Average Flexural Strength (ROR) | | | | | 303.123 |
| 1C | 0.699 | 50.023 | 50.057 | 500 | 458.345 |
| 2C | 0.697 | 50.023 | 50.057 | 500 | 472.529 |
| 3C | 0.696 | 50.023 | 50.057 | 500 | 294.512 |
| 4C | 0.696 | 50.023 | 50.057 | 500 | 261.300 |
| 5C | 0.701 | 50.023 | 50.057 | 500 | 459.444 |

| | |
|---|---|
| Average Flexural Strength (ROR) | 389.226 |

As shown in Table 1, Examples B and Examples C demonstrated about the same average flexural strength as compared to Examples A. Without being bound by theory, it is believed that the polymeric scratch resistant layer has a modulus that is low or lower than other hard coatings typically used for scratch resistance. When a flexural load is applied, it is believed that these other high modulus hard coatings fail or crack before the underlying substrate (usually glass) fails. It is believed that cracks originating in a high modulus hard coating propagate into the substrate and cause the substrate to fail prematurely (or under a lower load than it would fail if not combined with the hard coating), as compared substrates experiencing the same flexural load but not including the high modulus hard coating. It is believed that the lower modulus polymeric scratch resistant layer exhibits resistance to cracking and thus, cracks do not form as easily in the polymeric scratch resistant layer and do not propagate into the underlying substrate causing the underlying substrate to fail prematurely (or under a lower load than it would fail if not combined with the polymeric scratch resistant layer). Additionally or alternatively, without being bound by theory, it is believed that the polymeric scratch resistant layer also resists cracking due to its lubricity or low CoF. The lubricity of the polymeric scratch resistant layer causes or permits the polymeric scratch resistant layer to stretch when a flexural load is applied thereto and thereby prevents cracks from forming in the polymeric scratch resistant layer. The resistance to cracking prevents cracks from originating in the polymeric scratch resistant layer and propagating into the underlying substrate.

### Example 2

The exemplary laminates shown in Table 2 were prepared by depositing a polymeric scratch resistant layer onto various glass substrates to form laminates, under different deposition conditions using plasma-enhanced chemical vapor deposition. Each of the laminates were prepared by providing a glass substrate and forming a polymeric scratch resistant layer on the glass substrate using a DynaVac system having a 24 inch diameter water cooled electrode, and a 19 inch diameter platen for holding substrates. Argon was flowed into the reactor as a working gas and butane was flowed into the system as a source gas for carbon deposition. The system was plumbed for oxygen plasma which is used for chamber cleaning between deposition runs. The deposition was performed at a pressure of about 25 mtorr and the bias utilized was about 750 V between the electrode and the substrate platen to generate the plasma. Where a silicon coating was utilized as an adhesion promoter, the silicon coating was applied using a similar process as the polymeric scratch resistant layer but using a Si-source gas. RF power supplied to the system at 13.56 MMHz was varied as shown in Table 2. As also shown in Table 2, along with RF power, deposition time and butane flow rate was varied. In total, 134 samples were prepared, using a total of seven batch runs.

The substrates used for Examples 2A and 2B included glass substrates that were not strengthened and had a sample size of 5 square inches and 2 square inches, respectively. The glass substrates used for Examples 2A and 2B included an alkali aluminoborosilicate composition. The substrate used for Example 2C was chemically strengthened and had the same CS and DOL as the substrates used in Example 1. The substrate used for Examples 2C had a sample size of 2 square inches. The substrate used for Example 2D was chemically strengthened, included an alkali aluminoborosilicate composition and had a sample size of 2 square inches. The substrates used for Examples 2E and 2F included a known soda lime silicate composition and were not strengthened. The substrates used for Examples 2E and 2F had a thickness of about 0.55 mm and 1 mm, respectively. The substrates used for Examples 2G and 2H also included a known soda lime silicate composition and had a thickness of about 0.55 mm and 0.7 mm, respectively. The substrate of Example 2G was strengthened and exhibited a CS of 606 MPa and a DOL of 12 microns. The substrate of Example 2H was strengthened and exhibited a CS of 519 MPa and a DOL of 12 microns. Example 2I included the same substrate as Example 2B and included a silicon coating between the polymeric scratch resistant layer and the substrate. Example 2J included the same substrate as Example 2B and included an alumina coating between the polymeric scratch resistant layer and the substrate. Example 2K utilized the same substrate as Example 2C and included a silicon coating between the polymeric scratch resistant layer and the substrate. Example 2L included the same substrate as Example 2D and included a silicon coating between the polymeric scratch resistant layer and the substrate. Example 2M included the same substrate as Example 2H and included a silicon coating between the polymeric scratch resistant layer and the substrate.

TABLE 2
Deposition conditions for Runs 1-7

| | Run 1 | Run 2 | Run 3 | Run 4 | Run 5 | Run 6 | Run 7 |
|---|---|---|---|---|---|---|---|
| Deposition | 12 | 24 | 58 | 24 | 6 | 24 | 6 |
| Time | | | | | | | |
| (min) | | | | | | | |
| RF (W) at | 2000 | 2000 | 2000 | 3000 | 3000 | 1000 | 3000 |
| 13.56 MHz | | | | | | | |
| Butane | 15 | 15 | 15 | 10 | 15 | 15 | 25 |
| Flow rate | | | | | | | |
| (sccm) | | | | | | | |
| Polymeric | 262 | 528 | 1244 | 439 | 147 | 390 | 152 |
| scratch | | | | | | | |
| resistant | | | | | | | |
| layer | | | | | | | |
| thickness | | | | | | | |
| (nm) | | | | | | | |
| Deposition | 21.8333 | 22 | 21.4483 | 18.2917 | 24.5 | 16.25 | 25.3333 |
| rate | | | | | | | |
| (nm/min) | | | | | | | |

Number of Samples

| | | | | | | | |
|---|---|---|---|---|---|---|---|
| Ex. 2A | 2 | 2 | 4 | 2 | 2 | 2 | 4 |
| Ex. 2B | 4 | 4 | 4 | 4 | 4 | 4 | 4 |
| Ex. 2C | 4 | 4 | 4 | 4 | 4 | 4 | 4 |
| Ex. 2D | 4 | 4 | 4 | 4 | 4 | 4 | 4 |
| Ex. 2E | 0 | 0 | 1 | 1 | 1 | 0 | 0 |
| Ex. 2F | 0 | 0 | 1 | 0 | 0 | 1 | 0 |
| Ex. 2G | 0 | 0 | 1 | 0 | 0 | 1 | 0 |
| Ex. 2H | 0 | 0 | 1 | 0 | 0 | 1 | 0 |
| Ex. 2I | 0 | 0 | 1 | 0 | 0 | 1 | 0 |
| Ex. 2J | 4 | 0 | 0 | 0 | 0 | 0 | 0 |
| Ex. 2K | 0 | 0 | 1 | 0 | 0 | 1 | 0 |
| Ex. 2L | 0 | 0 | 1 | 0 | 0 | 1 | 0 |
| Ex. 2M | 0 | 0 | 0 | 0 | 0 | 1 | 0 |
| Total | 18 | 14 | 23 | 15 | 15 | 21 | 16 |

The samples were evaluated using an InVia Raman microscope. The Raman measurements were obtained at two different wavelengths, 442 nm and 514 nm. The dominant peak observed was the “G” peak that is related to sp² bond stretching graphitic modes in the polymeric scratch resistant layer. The Raman measurements were taken at the two different wavelengths to assess the shift in the “G” peak position with excitation energy, allowing the measurement of the dispersion (delta G peak position {nm}/delta wavelength {nm}). The dispersion is useful in determining the atomic bonding in the polymeric scratch resistant layer and, specifically, the ratio of sp² to sp^{a} bonded carbon and the amount of residual hydrogen in the film.

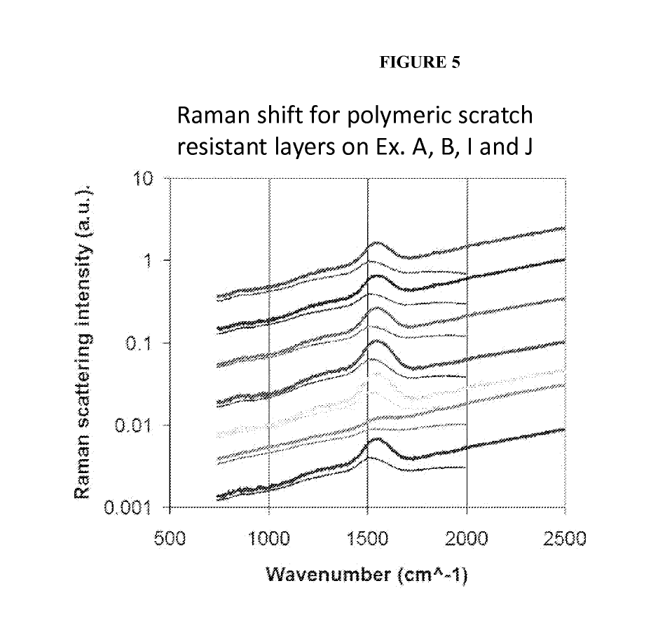

The Raman spectra were measured for the polymeric scratch resistant layer of all of the samples using 442 nm (denoted “A” in FIG. 5) and 514 nm (denoted “B” in FIG. 5) excitation. FIG. 5 illustrates the Raman spectra for Examples 2A, 2B, 2I and 2J for runs 1-7. In FIG. 5, the raw data is shown and is displaced vertically for comparison of the data between each run. The Raman spectra from run 1 is shown on top, with the spectra from runs 2-7 shown underneath in sequential order such that the Raman spectra from run 7 is at the bottom. The line shapes for all of the Raman spectra in FIG. 5 are nearly identical. As shown in FIG. 5, the G-band occurs at about 1550 cm⁻¹ for 514 nm excitation and occurs at about 1525 cm⁻¹ for 442 nm excitation. This corresponds to a dispersion, D=(1550-1525) cm⁻¹/(514-442) nm, or about 0.34 cm⁻¹/nm. The data shows that the full-width at half maximum (FWHM) for the G-band is approximately 125 to 150 cm⁻¹.

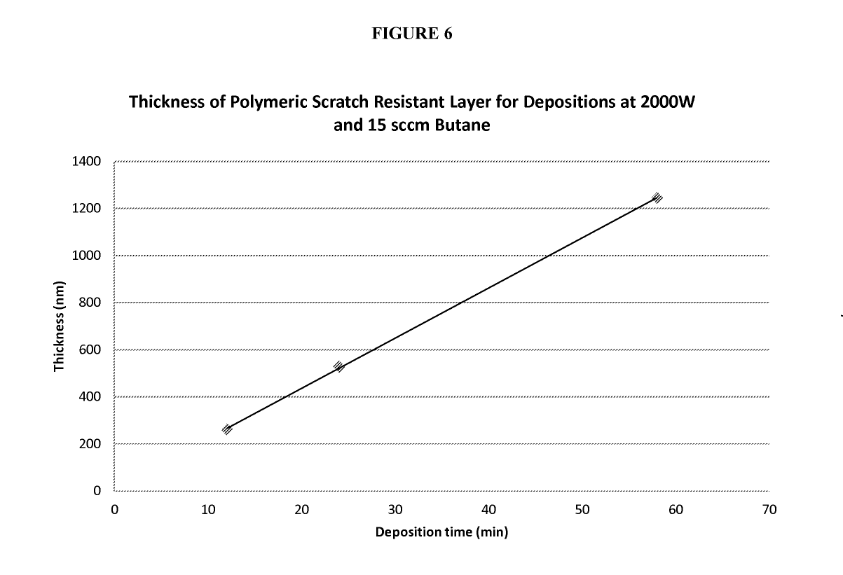

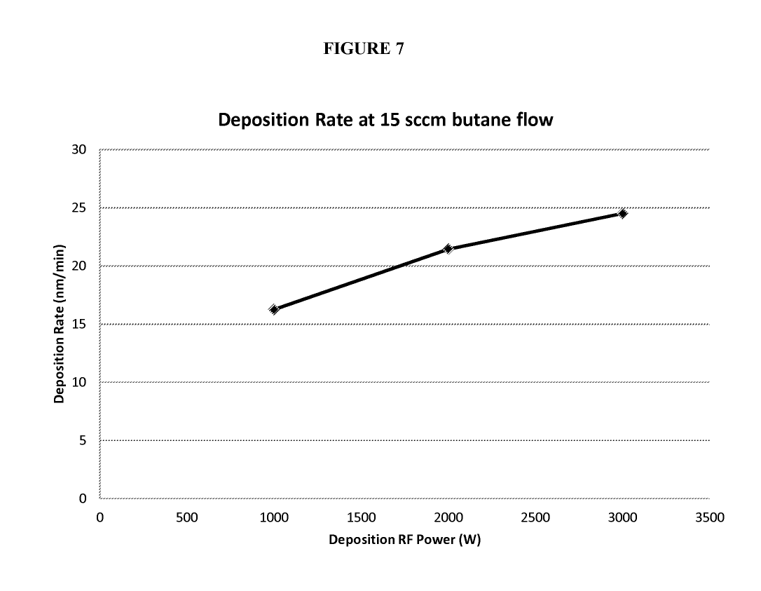

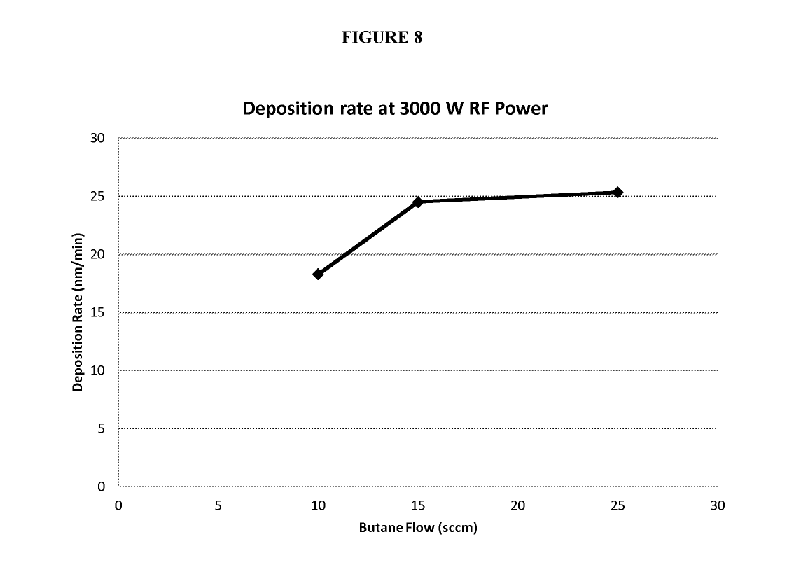

The samples were also measured to determine the thickness of the polymeric scratch resistant layer using ellipsometry. The thickness as a function of time is shown in FIG. 6 for runs 1, 2, and 3. As shown in FIG. 6, the deposition rate is linear in time and was about 22 nm/min for runs 1, 2, and 3. The deposition rate increased with RF power, as shown in FIG. 7 for runs 3, 5, and 6. The deposition rate appears to saturate at about 25 nm/min with increasing butane flow for runs 4, 5, and 7, as shown in FIG. 8.

The samples were also tested using a nano-indentation test using a Berkovitch diamond indenter. The Berkovitch diamond indenter was used to furrow scratches into the surface of the polymeric scratch resistant layer of each sample. In the test, the tip of the Berkovitch diamond indenter was brought into contact with the surface of the sample. The nano-indentation test included the following steps.
1) The tip is scanned across the sample to establish a surface profile.
2) After establishing the surface profile, the tip is scanned across the same surface contour again but with the addition of a linearly time-varying load (which ranged from 0 to 120 mN) that is applied to the tip during the durations of the scan. The increasing load applied to the tip during the scan results in the formation of a scratch of increasing depth.
3) After formation of a scratch of increasing depth, the tip is then used to rescan the surface contour of the scratch that was just formed on the sample, thus recording how deep the scratch has gone into the sample's surface.

The nano-indentation test is capable of yielding the original surface curvature, the scratch depth under load and the depth of the final plastically formed scratch in the sample. In addition, the nano-indentation test is also capable of yielding the hardness and the modulus of the sample being tested.

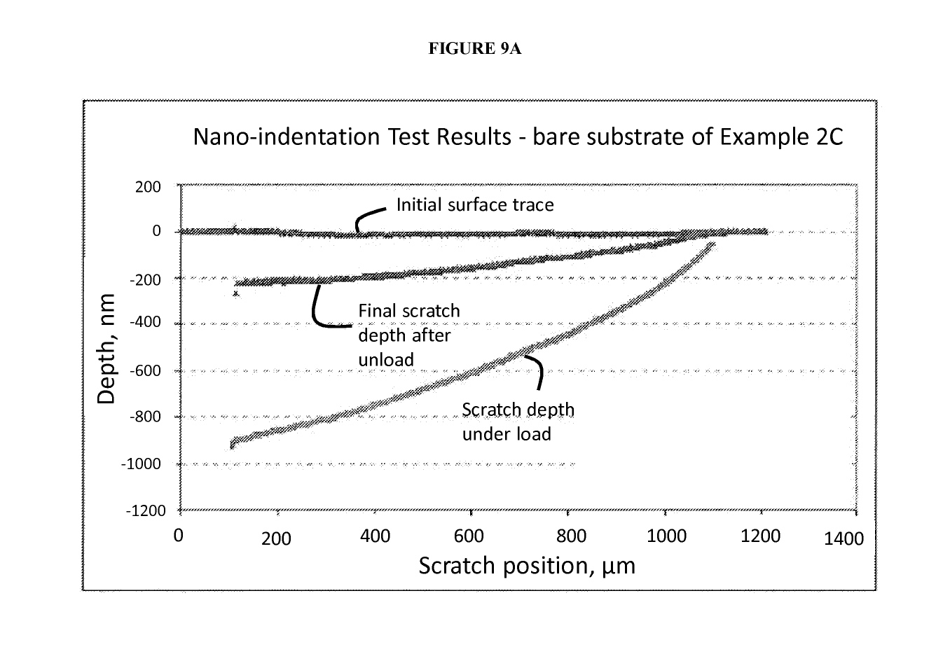

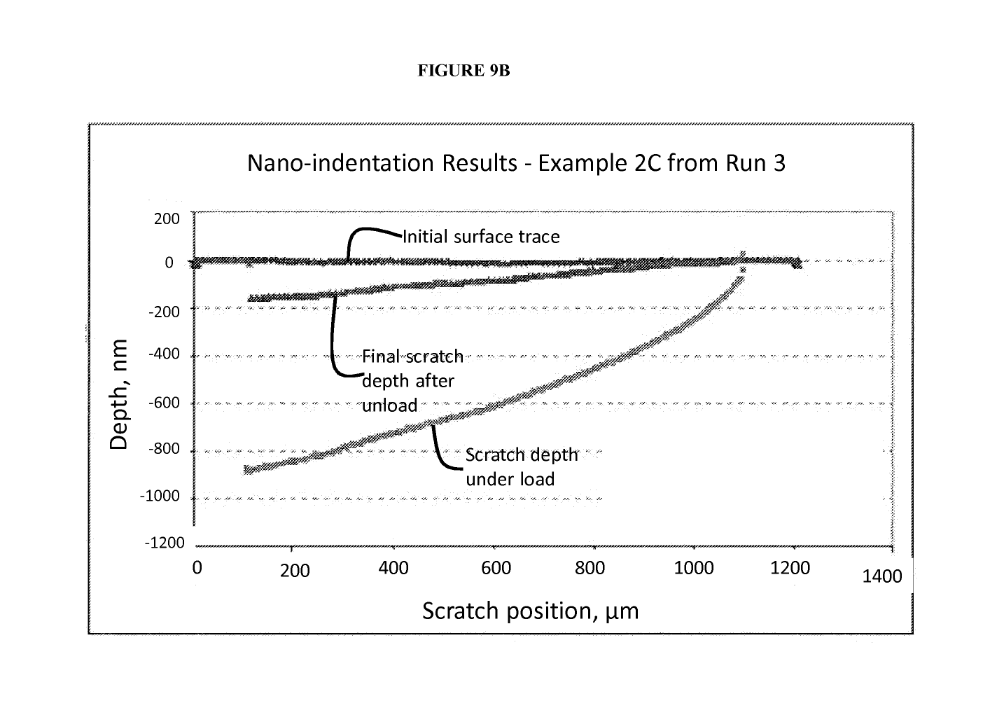

FIGS. 9A and 9B illustrate plots that resulted from the nano-indentation test of one sample of the embodiment of the glass substrate used in Example 2C without a polymeric scratch resistant layer and of Example 2C from run 3, respectively. The original contour of the surface of a sample measured using a Berkovitch diamond indenter is plotted as a function of position and is the top line in FIGS. 9A and 9B. The scratch depth under load measured using a Berkovitch diamond indenter is shown as the bottom line in FIGS. 9A and 9B. The resulting scratch that was formed in the sample was measured using the same Berkovitch diamond indenter but under zero applied load and is shown as the middle line. The scratch depth for the bare glass substrate used in Example 2C was about 205 nm and the scratch depth for the sample of Example 2C was about 190 nm, which is a decrease in scratch depth of about 7%. As shown in FIGS. 9A and 9B the resulting scratch (the middle line) is about 15 nm deeper in the bare substrate used in Example 2C than in the sample of Example 2C, which includes the polymeric scratch resistant layer. Accordingly, a laminate that includes a polymeric scratch resistant layer exhibits reduced scratch depth as compared to a bare glass substrate that does not include a polymeric scratch resistant layer.

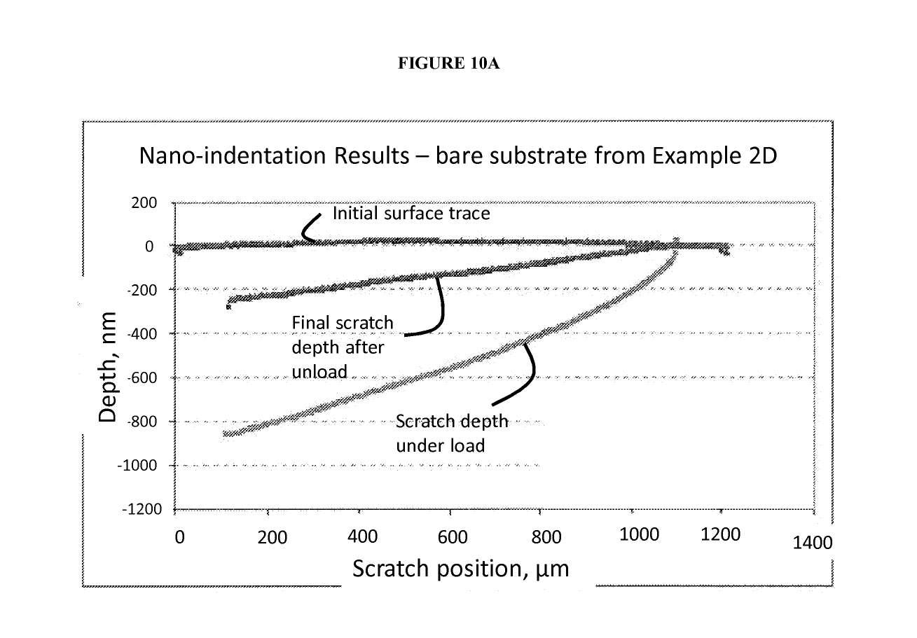

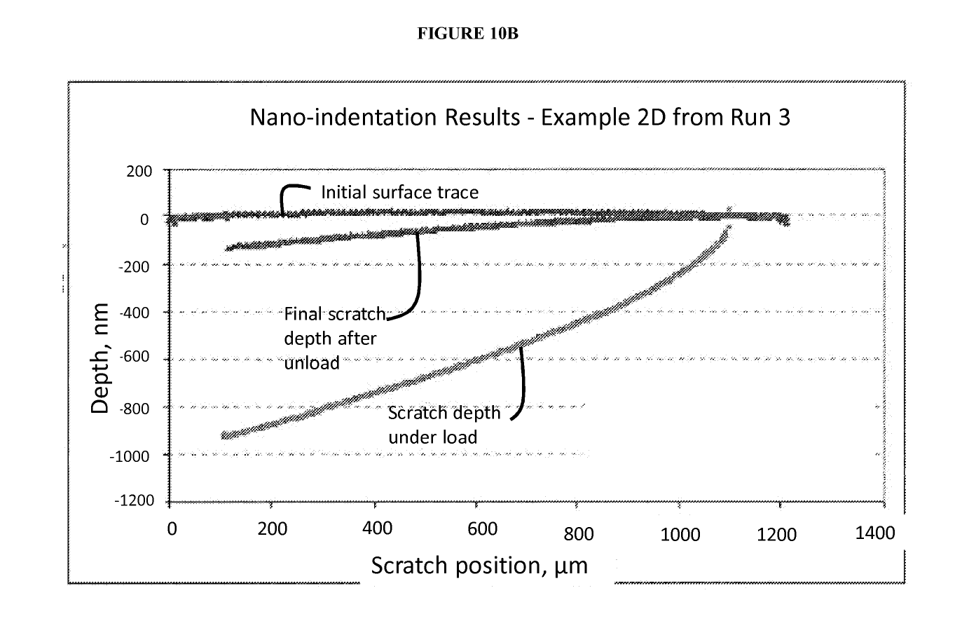

FIGS. 10A and 10B illustrate plots that resulted from the nano-indentation test of one sample of the glass substrate used in Example 2D without a polymeric scratch resistant layer and the embodiment of Example 2D from run 3, respectively. The original contour of the surface of a sample measured using a Berkovitch diamond indenter is plotted as a function of position and is the top line in FIGS. 10A and 10B. The scratch depth under load measured using a Berkovitch diamond indenter is shown as the bottom line in FIGS. 10A and 10B. The resulting scratch that was formed in the sample was measured using the same Berkovitch diamond indenter but under zero applied load and is shown as the middle line. The scratch depth for the bare glass substrate used in Example 2D was about 210 nm and the scratch depth for the sample of Example 2D was about 170 nm, which is a decrease in scratch depth of about 19%. As shown in FIGS. 10A and 10B the resulting scratch (the middle line) is about 40 nm deeper in the bare substrate used in Example 2D than in the sample of Example 2D, which includes the polymeric scratch resistant layer. Accordingly, a laminate that includes a polymeric scratch resistant layer exhibits reduced scratch depth as compared to a bare glass substrate that does not include a polymeric scratch resistant layer.

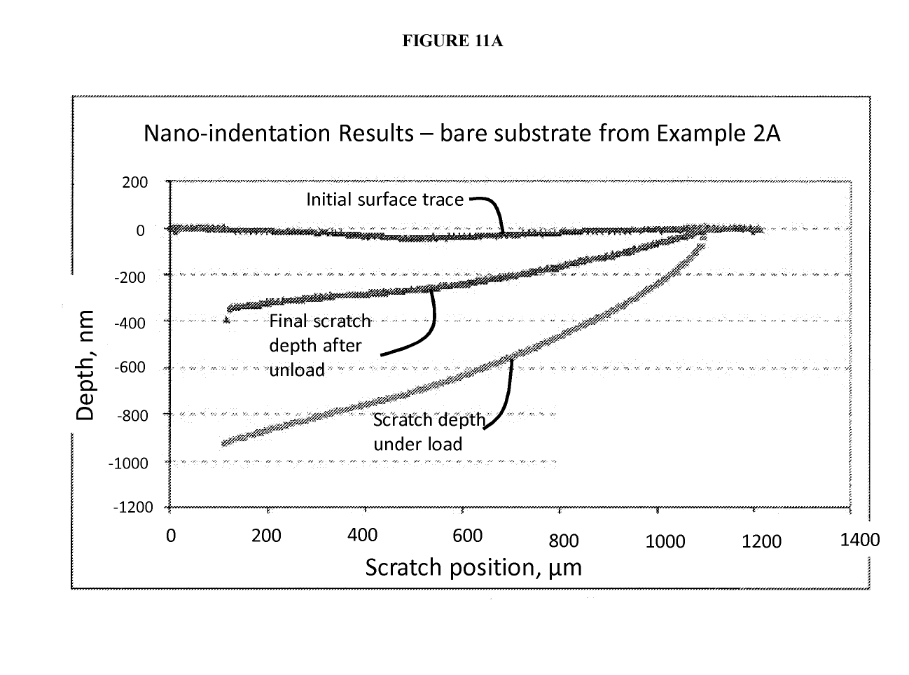

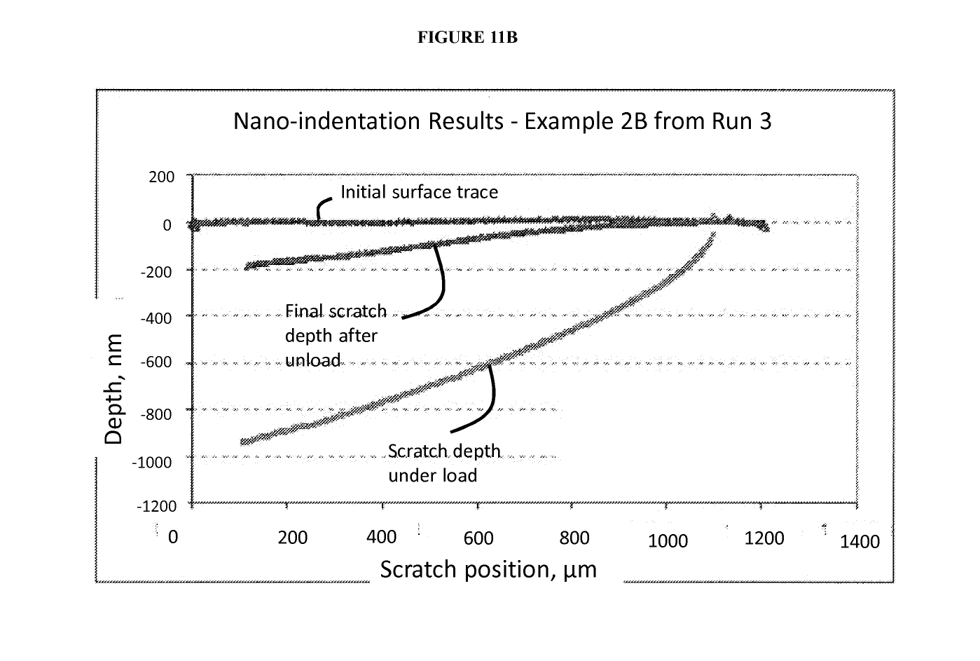

FIGS. 11A and 11B illustrate plots that resulted from the nano-indentation test of one sample of the glass substrate used in Example 2B without a polymeric scratch resistant layer and the embodiment of Example 2B from run 3, respectively. The original contour of the surface of a sample measured using a Berkovitch diamond indenter is plotted as a function of position and is the top line in FIGS. 11A and 11B. The scratch depth under load measured using a Berkovitch diamond indenter is shown as the bottom line in FIGS. 11A and 11B. The resulting scratch that was formed in the sample was measured using the same Berkovitch diamond indenter but under zero applied load and is shown as the middle line. The scratch depth for the bare glass substrate used in Example 2B was about 280 nm and the scratch depth for the sample of Example 2B was about 200 nm, which indicates a decrease in scratch depth of about 28%. As shown in FIGS. 11A and 11B the resulting scratch (the middle line) is about 80 nm deeper in the bare substrate used in Example 2B than in the sample of Example 2B, which includes the polymeric scratch resistant layer. Accordingly, a laminate that includes a polymeric scratch resistant layer exhibits reduced scratch depth as compared to a bare glass substrate that does not include a polymeric scratch resistant layer.

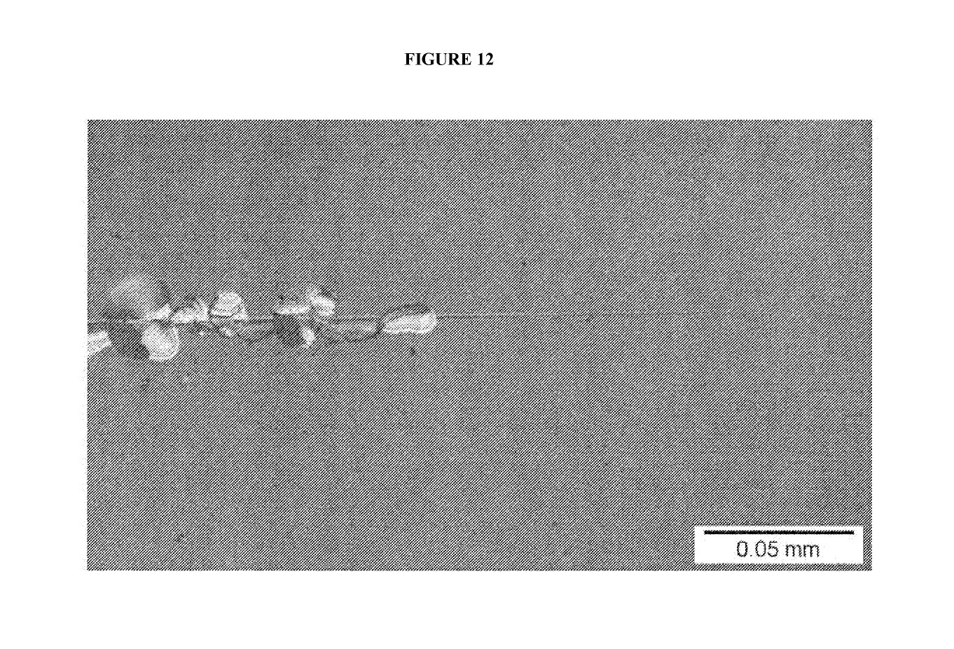

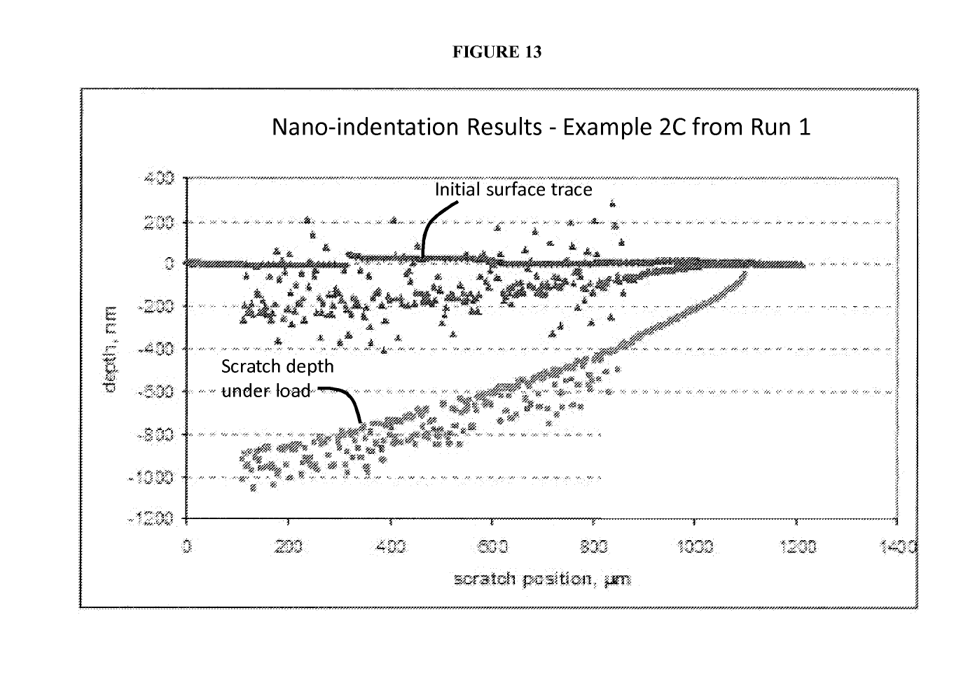

The adhesion of the polymeric scratch resistant layer to the underlying substrate was evaluated. FIG. 12 is an optical microscope image of a laminate sample after nano-indentation testing showing delamination of the polymeric scratch resistant layer. After a laminate is scratched, any lateral cracking (as shown in FIG. 12) at the interface between the polymeric scratch resistant layer and substrate indicates that the film may have delaminated at least partially. In some nano-indentation tests, as shown in the plot of FIG. 13, delamination events cause the scratch depth measurements using the Berkovitch diamond indenter to appear “noisy”. FIG. 13 illustrates the nano-indentation test results of one sample of the embodiment of Example 2C from run 1. The onset of lateral cracking or delamination corresponds to the onset of apparent “noise” in a scratch test plot. The onset of delamination occurs at a critical load that can be interpreted as a measure of the adhesion strength of the polymeric scratch resistant layer.

The critical load, hardness (H) and modulus (E) of Examples 2B, 2C and 2D. The critical load was determined using the nano-indentation test described above. As shown in Table 3, the polymeric scratch resistant layers from the samples from runs 3, 4 and 5 did not show any delamination up to the maximum load of 120 mN. On the other hand, some of the polymeric scratch resistant layers from the samples from run 4 showed delamination with zero load.

Modulus and hardness of the polymeric scratch resistant layers was determined using the Oliver-Pharr method, and are provided in Table 3. As shown in Table 3, the polymeric scratch resistant layers exhibiting the highest hardness values (i.e., those from runs 4, 5, and 7) were also the layers that were deposited with the highest power (e.g., 3 kW, as shown in Table 2). In addition, Table 3 shows that modulus scaled with hardness.

TABLE 3
Modulus (E), Hardness (H) and Critical (delamination) Load

| | | | Scratch delamina- |
|---|---|---|---|
| | Modulus | Hardness | tion critical load |
| Sample | (GPa) | (GPa) | (mN) |
| Ex. 2B, run 1 | 39 | 5.4 | 21.8 |
| Ex. 2C, run 1 | 41 | 5.6 | 29.9 |
| Ex. 2D, run 1 | 40 | 5.5 | 29.9 |
| Ex. 2B, run 2 | 40 | 5.3 | 48.4 |
| Ex. 2C, run 2 | 41 | 5.4 | 69 |
| Ex. 2D, run 2 | 39 | 5.0 | 63.2 |
| Ex. 2B, run 3 | 39 | 4.8 | 120 |
| Ex. 2C, run 3 | 45 | 5.7 | 120 |
| Ex. 2D, run 3 | 38 | 4.9 | 120 |
| Ex. 2B, run 4 | Delamination at zero load | | |
| Ex. 2C, run 4 | 63 | 7.5 | 120 |
| Ex. 2D, run 4 | Delamination at zero load | | |
| Ex. 2B, run 5 | 54 | 6.8 | 120 |
| Ex. 2C, run 5 | 55 | 6.4 | 120 |
| Ex. 2D, run 5 | 52 | 6.2 | 120 |
| Ex. 2B, run 6 | 30 | 4.1 | 41 |
| Ex. 2C, run 6 | 34 | 4.5 | 28.6 |
| Ex. 2D, run 6 | 32 | 4.2 | 29.4 |
| Ex. 2B, run 7 | 40 | 5.2 | 65.3 |
| Ex. 2C, run 7 | 48 | 5.9 | 94.7 |
| Ex. 2D, run 7 | 48 | 5.6 | 27.8 |

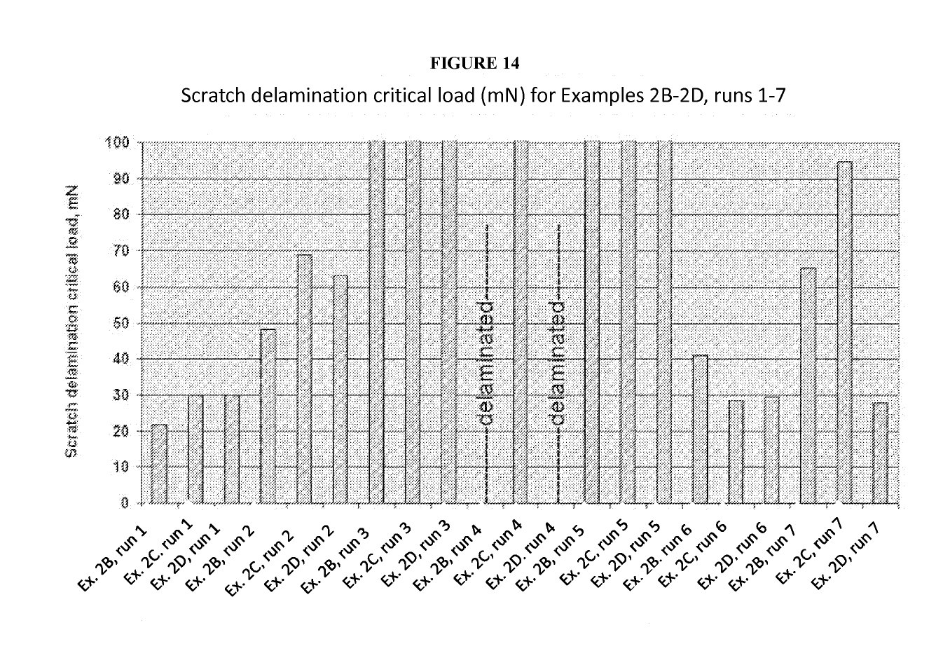

FIG. 14 shows a plot of the critical delamination load for a range of samples. From FIG. 14, it can be seen that runs 3, 4, and 5 produced the most strongly adhered polymeric scratch resistant layers among all the runs. In addition, FIG. 14 illustrates the dependence on critical load (for delamination) on the thickness of the polymeric scratch resistant layer, as demonstrated in runs 1, 2 and 3; as the polymeric scratch resistant layer becomes thicker, it tends to be more resistant to delamination.

While the disclosure has been described with respect to a limited number of embodiments for the purpose of illustration, those skilled in the art, having benefit of this disclosure, will appreciate that other embodiments can be devised which do not depart from the scope of the disclosure as disclosed herein. Accordingly, various modifications, adaptations and alternatives may occur to one skilled in the art without departing from the spirit and scope of the present disclosure.

1. A laminate, comprising:
a transparent substrate having opposing major surfaces and exhibiting an average flexural strength; and
a polymeric scratch resistant layer disposed on a first major surface, wherein the polymeric scratch resistant layer comprises a load-sensitive coefficient of friction that decreases with increasing load applied to the polymeric scratch resistant layer.

2. The laminate of claim 1, wherein the polymeric scratch resistant layer comprises a coefficient of friction in the range from about 0.05 to less than about 0.4.

3. The laminate of claim 1, wherein the average flexural strength of the substrate is maintained when the polymeric scratch resistant layer is disposed on the first major surface.

4. The laminate of claim 1, wherein the polymeric scratch resistant layer comprises polymeric diamond-like carbon.

5. The laminate of claim 1, wherein the polymeric scratch resistant layer absorbs energy from a contact force applied to the polymeric scratch resistant layer.

6. The laminate of claim 1, wherein the polymeric scratch resistant layer comprises a non-zero hardness up to about 20 GPa.

7. The laminate of claim 1, wherein the polymeric scratch resistant layer comprises a thickness in the range from about 2 nm to about 3 μm.

8. The laminate of claim 1, wherein the polymeric scratch resistant layer comprises a plurality of sub-layers.

9. The laminate of claim 1, wherein the polymeric scratch resistant layer exhibits viscoelastic behavior upon application of a force to the polymeric scratch resistant layer.

10. The laminate of claim 1, wherein the substrate is selected from the group consisting of a chemically-strengthened glass substrate and a sapphire substrate.

11. The laminate of claim 10, wherein the substrate comprises a chemically-strengthened glass substrate exhibiting a surface compressive strength greater than 500 MPa, a central tension greater than 18 MPa, and a depth of compressive layer greater than about 15 μm.

12. An electronic device comprising the laminate of claim 1.

13. The laminate of claim 1, further exhibiting an average light transmission in the range from about 70% to about 90%, over the visible spectrum in the range from about 380 nm to about 780 nm.

14. A laminate, comprising:
a substrate having opposing major surfaces; and
a polymeric scratch resistant layer disposed on a first major surface, the polymeric scratch resistant layer comprising a greater number of hydrogen-carbon bonds than carbon-carbon bonds,
wherein the polymeric scratch resistant layer is deformable and comprises a plurality of polymeric chains forming a network, and wherein the deformation of the polymeric scratch resistant layer causes shearing between the polymeric chains.

15. The laminate of claim 14, wherein the polymeric scratch resistant layer and the substrate form a shearable interface.

16. The laminate of claim 14, wherein the substrate comprises a first average flexural strength and the laminate exhibits a second average flexural strength that is at least 90% of the first average flexural strength of the substrate.

17. The laminate of claim 14, wherein the polymeric scratch resistant layer comprises a plurality of sub-layers and a plurality of shearable interfaces between the plurality of sub-layers.

18. The laminate of claim 14, wherein the polymeric scratch resistant layer comprises a non-zero amount of hydrogen up to about 40 atomic %.

19. An electronic device comprising the laminate of claim 14.

20. The electronic device of claim 19, further comprising a mobile phone, a tablet, a laptop, a television, or a display.
